(19) United States
(12) Patent Application Publication
(10) Pub. No.: US 2025/0155962 A1
(43) Pub. Date: May 15, 2025

(54) MIXED REALITY DATA STREAM BASED DEVICE CONTROL

(71) Applicant: Microsoft Technology Licensing, LLC, Redmond, WA (US)

(72) Inventors: Peter DOIDGE-HARRISON, North Vancouver (CA); Christopher Lee MULLINS, Sammamish, WA (US); Shirley Hiu Yan HO, Coquitlam (CA)

(21) Appl. No.: 18/389,334

(22) Filed: Nov. 14, 2023

(51) Int. Cl. G06F 3/01; G06F 3/0487; G06T 11/00

(52) U.S. Cl. CPC G06F 3/011; G06F 3/0487; G06T 11/00; G06T 2200/24; G06T 2210/62

(57) ABSTRACT

Mixed reality instructional technology is enhanced. Comparison of a guide mixed reality data stream to a candidate mixed reality data stream detects a deviation, e.g., different hand movement, different tool placement, or different sensor telemetry. Experiencing a feedback stream of output that is based on the deviation facilitates device control and helps candidates improve their skills. Some feedback output emphasizes deviation size, e.g., by varying colors, sounds, or haptic output proportionally to the deviation size. Some feedback output renders a translucent or skeletal guide overlaid on a live video of current candidate activity. Some embodiments support searches whose results show, e.g., how a certain expert performed a task differently than the candidate, or examples of a certain task such as widget replacement in the field. Stream optimization, summarization, synchronization, and other stream derivation functionality is provided.

### BACKGROUND

Mixed reality images combine real-world imagery such as photographs or video of actual people, actual places, or actual things, with computer-generated imagery such as overlaid text, graphics, or animation. Augmented reality is an example of mixed reality that combines real and virtual worlds for real-time interactions. Mixed reality technologies continue to undergo changes, but improvements are still possible.

### SUMMARY

Some embodiments address technical challenges arising from efforts to add instructional content to instructional videos. Some embodiments address technical challenges arising from efforts to enhance augmented reality tools.

Some embodiments computationally detect a deviation between a candidate mixed reality data stream and a guide mixed reality data stream, computationally create a feedback stream based at least in part on the deviation, and actuate a user interface hardware output device according to at least a portion of the feedback stream. In some scenarios, at least one of the mixed reality data streams includes video data. In some scenarios, at least one of the mixed reality data streams includes a digital representation of a real-world device. In some scenarios, the feedback stream includes instructional content which assists a person in configuring, constructing, disassembling, emptying, filling, inspecting, monitoring, operating, positioning, repairing, testing, upgrading, or otherwise controlling the real-world device.

Other technical activities and characteristics pertinent to teachings herein will also become apparent to those of skill in the art. The examples given are merely illustrative. This Summary is not intended to identify key features or essential features of the claimed subject matter, nor is it intended to be used to limit the scope of the claimed subject matter. Rather, this Summary is provided to introduce—in a simplified form—some technical concepts that are further described below in the Detailed Description. Subject matter scope is defined with claims as properly understood, and to the extent this Summary conflicts with the claims, the claims should prevail.

### BRIEF DESCRIPTION OF THE DRAWINGS

A more particular description will be given with reference to the attached drawings. These drawings only illustrate selected aspects and thus do not fully determine coverage or scope.

FIG. 1 is a diagram illustrating aspects of computer systems and also illustrating configured storage media, including some aspects generally suitable for systems which provide mixed reality data stream analysis functionality suitable for real-world device control instruction;

FIG. 2 is a block diagram illustrating aspects of enhanced systems which are each configured with mixed reality data stream analysis functionality suitable for real-world device control instruction;

FIG. 3 is an architecture data flow diagram also illustrating aspects of enhanced systems which are each enhanced with mixed reality data stream analysis functionality suitable for real-world device control instruction;

FIG. 4 is a block diagram illustrating some aspects of mixed reality data stream analysis and device control facilitation;

FIG. 5 is a block diagram illustrating some aspects of mixed reality data stream content;

FIG. 6 is a block diagram illustrating some aspects of hardware output devices;

FIG. 7 is a diagram illustrating different kinds of data stream content with stylized depictions suitable for a patent disclosure;

FIG. 8 is a flowchart illustrating steps in a mixed reality data stream analysis and device control facilitation method; and

FIG. 9 is a flowchart further illustrating steps in some mixed reality data stream analysis and device control facilitation methods, and incorporating steps from FIGS. 3, 7, 8, and text of the present disclosure.

### DETAILED DESCRIPTION

### Overview

Some teachings described herein were motivated by technical challenges faced during efforts to improve technology for field service applications or frontline worker scenarios, including mixed reality applications which permit a remote expert or trainer to view and comment in real time on the activities of local field service personnel or deskless workers at a customer site or at their own company's site. In particular, challenges were faced during efforts to improve applications employing Microsoft HoloLens® devices, which are head-mounted augmented reality devices (mark of Microsoft Corporation). HoloLens® devices are also referred to as mixed reality headsets or augmented reality headsets. These challenges were motivations, but teachings herein are not limited in their scope or applicability to these particular motivational challenges.

Some familiar approaches to providing instructional content about controlling a real-world device involve recording video of an expert performing an operation on the real-world device. Then field service personnel or other people who are being trained or expected to perform that operation playback and watch the recorded video. Spoken or captioned narration is sometimes part of the video. In some cases, the video is also annotated with overlaid graphics, e.g., a circle inked around a particular component of interest or an arrow pointing to a particular area of interest. Such recorded videos can be quite helpful.

However, this approach also has significant disadvantages. One disadvantage of relying primarily or solely on conventional recorded instructional videos is that the instruction is not in real time, e.g., first the student watches a video and then later the student attempts to apply the video's instructional content in practice. This delay between watching and doing makes it difficult for a student to make corrections, additions, or other adjustments in real time.

Another disadvantage of relying heavily on conventional recorded instructional videos is that the student must switch their mental attention, and their visual focus, between two environments-one which is depicted in the video recording and the other which is in front of the student in reality. This repeated switching interrupts the student's work flow, and burdens the student. Either the student must continually try to recall the video from their memory, or else the student must repeatedly run and pause the video to try and match the video's operation progress to the real-world operation progress in front of the student.

A different approach is to have the expert present when the student attempts to perform the operation. In some cases, the expert is present physically, while in other cases the expert is present virtually, i.e., in real time communication with the student via a telephone call or a video conference call, for example. However, this approach is often not practical because of the expert's limited availability, or the expert's consultation fee, or because of a desire to train multiple students using instructions from a single expert, for example.

Accordingly, other technical approaches are taught herein which improve the efficiency, effectiveness, flexibility, and ease of use of instructional data streams for instructions on controlling a real-world device. The approaches taught herein include video in some but not all scenarios. Many of the approaches taught herein include additional or different content beyond mere recorded video and conventional video annotations.

Some embodiments described herein analyze mixed reality data streams based on controlling a real-world device, by getting a candidate mixed reality data stream, obtaining a guide mixed reality data stream, at least one of the mixed reality data streams including a digital representation of the real-world device, computationally detecting a deviation between the candidate mixed reality data stream and the guide mixed reality data stream, computationally creating a feedback stream based at least in part on the deviation, and actuating a user interface hardware output device according to at least a portion of the feedback stream. Students, trainees, and field service personnel are some examples of “candidates” herein.

This mixed reality data stream analysis functionality has the technical benefit of providing instructional content to a candidate, including feedback about the candidate's ongoing performance of an operation, without requiring the candidate to repeatedly switch their mental attention and their visual focus between a recording and reality. The functionality thus improves the candidate's ease of use of instructional data, and the effectiveness of the instructional content of the guide mixed reality data stream in training the candidate. Moreover, the feedback can be provided in real time, and it can be provided without requiring the live presence of an expert.

Some embodiments also identify in at least one of the mixed reality data streams a digital representation of a control action which is directed at the real-world device, and monitor the real-world device for a response to the control action. For example, in some scenarios the guide stream shows a desired positioning of a real-world tool relative to a machine during an operation to repair the machine. Positioning a tool relative to a machine is an example of controlling the tool. Then the embodiment monitors the tool for a response to the positioning action. This mixed reality data stream analysis functionality has the technical benefit of improving the efficiency and effectiveness of a control action, such as tool positioning actions, by providing prompt feedback about the result of the control action.

In some scenarios, an embodiment uses the monitored response as a basis to alter the feedback. For example, when the tool positioning brings the tool within a predefined tolerance of the correct position specified in the guide stream, the feedback stream actuates one or more output devices to show a green light, emit a bell tone, or provide a single haptic click. Conversely, when the tool positioning brings the tool outside the predefined tolerance the feedback stream actuates one or more output devices to show a red light, emit a buzz tone, or provide a burst of several rapid haptic clicks. This has the technical benefit of improving the efficiency and effectiveness of the control action. Haptic feedback mechanisms and audio feedback mechanisms also have the technical benefit of improving accessibility.

Some embodiments submit, to a search mechanism, a search constraint and an identifier of at least one of the mixed reality data streams to be searched based on at least the search constraint, receive a search result from the search mechanism, and configure a user interface according to at least a portion of the search result. This mixed reality data stream analysis functionality has the technical benefit of improving the ease of use of the instructional content of guide streams by making it easier to locate a guide stream having specified characteristics of interest. For example, a candidate may search for guide streams about a particular tool, or guide streams from a particular date range, or guide streams showing a particular expert. Some embodiments also support searching a particular topic within a stream. In one scenario, a search is performed to locate the portion of a guide which shows the particular buttons pushed by a person who previously fixed a specified model of electrical panel interface. Such searches can be based on preprocessing of guides that utilizes object recognition, for example, or speech conversion to searchable text.

Some embodiments also provide proactive automatically generated searches, which are not user-initiated. In some scenarios, a trained machine learning model suggests search constraints, or proactively performs a search, based on user activity, or based on prior searches by the same user, or based on searches by other users, such as users who viewed the same expert video or users who viewed another data stream with overlapping recorded telemetry. This proactive search functionality has the technical benefit of reducing a burden on users to formulate relevant searches.

In some embodiments, a guidance forge (a.k.a. guidance formulation subsystem) is configured to, upon execution by a processor set, measure a size of the deviation between the candidate mixed reality data stream and the guide mixed reality data stream, create the feedback stream based at least in part on the size of the deviation, and actuate the user interface hardware output device according to at least the size of the deviation. This mixed reality data stream analysis functionality has the technical benefit of helping candidates more quickly and accurately perform an operation in the real world that corresponds closely to the operation recorded in the guide stream. The size of the deviation gives the candidate direction that is not provided by a less granular and non-graduated mere correct versus incorrect feedback.

In some embodiments, the guidance forge is configured to create the feedback stream at least in part by computationally compositing a guide derivation of the guide mixed reality data stream over a candidate derivation of the candidate mixed reality data stream, and the guide derivation is at least one of: translucent, partially transparent, displayed as an outline, displayed as a skeleton, or visually blocking less than one third of the candidate derivation. For example, some embodiments provide a ghost mode in which a so-called ghost of the guide stream is overlaid on the candidate stream to produce a displayed feedback stream. The guide stream ghost is a derivation of the guide stream. The FIG. 7 lower left example depicts a skeleton outline ghost on top of a candidate live stream image.

This mixed reality data stream analysis functionality has the technical benefit of helping candidates more quickly and accurately perform an operation in the real world that corresponds closely to the operation recorded in the guide stream. In particular, candidates are not required to repeatedly switch their mental attention and their visual focus between an instructional recording screen and a candidate's local reality screen, because the ghost images of the recording is displayed on top of, and on the same screen as, the candidate's current real-world reality images.

In some embodiments, at least one of the mixed reality data streams includes a digital articulated body representation which digitally represents at least one of: a human hand, a human limb, at least a portion of a human body, a robotic hand, a robotic limb, at least a portion of a robotic mechanism, a manually operable non-powered physical tool other than a software tool, or a powered physical tool other than a software tool. The FIG. 7 upper right, lower left, and lower right examples each depict a digital articulated body representation which digitally represents a human hand. This mixed reality data stream analysis functionality has the technical benefit of facilitating control of real-world devices by more accurately representing such devices as well as entities (candidates, robots, tools) that perform control actions on real-world devices, in the context of instructional content.

In some embodiments, at least one of the mixed reality data streams includes particular kinds of data, such as sensor data from a living body, or sensor data from a non-living object or environment. In some embodiments, sensor data from a living body includes one or more of: head pose data, eye tracking data, articulated body position data, articulated body speed data, articulated body acceleration data, respiration data, blood pressure data, living body temperature data, skin sensor data, ingested sensor data, or spatiotemporal data. In some embodiments, sensor data from a non-living object or environment includes one or more of: speed data other than articulated body speed data, acceleration data other than articulated body acceleration data, gyroscopic data, pressure data other than blood pressure data, torque data, temperature data other than living body temperature data, humidity data, electromagnetic power data, electromagnetic field data, chemical composition data, relative concentration data, sensor data representing a real-world non-human object physical condition, or sensor data representing a real-world environment physical condition. This mixed reality data stream analysis functionality has the technical benefit of providing greater flexibility, providing additional content not typically present in mere videos, and promoting greater accuracy regarding the state and environment of real-world devices. This in turn improves the efficiency and effectiveness of actions to control real-world devices.

These and other benefits will be apparent to one of skill from the teachings provided herein.

### Operating Environments

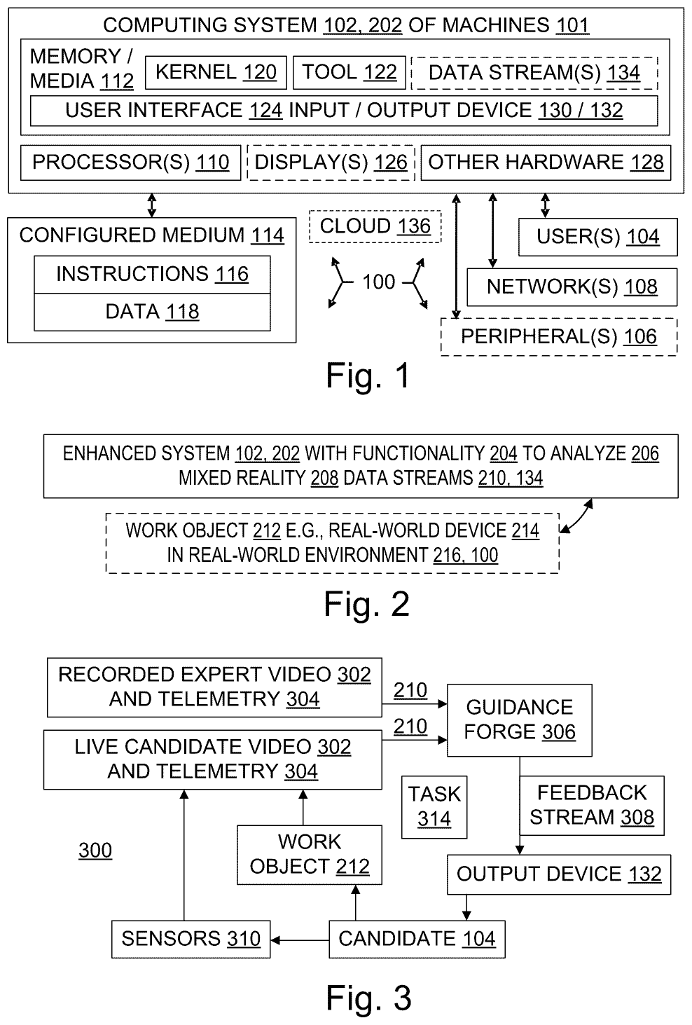

With reference to FIG. 1, an operating environment 100 for an embodiment includes at least one computer system 102. The computer system 102 may be a multiprocessor computer system, or not. An operating environment may include one or more machines in a given computer system, which may be clustered, client-server networked, and/or peer-to-peer networked within a cloud 136. An individual machine is a computer system, and a network or other group of cooperating machines is also a computer system. A given computer system 102 may be configured for end-users, e.g., with applications, for administrators, as a server, as a distributed processing node, and/or in other ways.

Human users 104 sometimes interact with a computer system 102 user interface 124 by using displays 126, keyboards 106, and other peripherals 106, via typed text, touch, voice, movement, computer vision, gestures, and/or other forms of I/O. Virtual reality or augmented reality or both functionalities are provided by a system 102 in some embodiments. A screen 126 is a removable peripheral 106 in some embodiments and is an integral part of the system 102 in some embodiments. The user interface supports interaction between an embodiment and one or more human users. In some embodiments, the user interface includes one or more of: a command line interface, a graphical user interface (GUI), natural user interface (NUI), voice command interface, or other user interface (UI) presentations, presented as distinct options or integrated.

System administrators, network administrators, cloud administrators, security analysts and other security personnel, operations personnel, developers, testers, engineers, auditors, and end-users are each a particular type of human user 104. In some embodiments, automated agents, scripts, playback software, devices, and the like running or otherwise serving on behalf of one or more humans also have user accounts, e.g., service accounts. Sometimes a user account is created or otherwise provisioned as a human user account but in practice is used primarily or solely by one or more services; such an account is a de facto service account. Although a distinction could be made, “service account” and “machine-driven account” are used interchangeably herein with no limitation to any particular vendor.

Storage devices or networking devices or both are considered peripheral equipment in some embodiments and part of a system 102 in other embodiments, depending on their detachability from the processor 110. In some embodiments, other computer systems not shown in FIG. 1 interact in technological ways with the computer system 102 or with another system embodiment using one or more connections to a cloud 136 and/or other network 108 via network interface equipment, for example.

Each computer system 102 includes at least one processor 110. The computer system 102, like other suitable systems, also includes one or more computer-readable storage media 112, also referred to as computer-readable storage devices 112. In some embodiments, tools 122 include security tools or software applications, on mobile devices 102 or workstations 102 or servers 102, editors, compilers, debuggers and other software development tools, as well as APIs, browsers, or webpages and the corresponding software for protocols such as HTTPS, for example. Files, APIs, endpoints, and other resources may be accessed by an account or set of accounts, user 104 or group of users 104, IP address or group of IP addresses, or other entity. Access attempts may present passwords, digital certificates, tokens or other types of authentication credentials.

Storage media 112 occurs in different physical types. Some examples of storage media 112 are volatile memory, nonvolatile memory, fixed in place media, removable media, magnetic media, optical media, solid-state media, and other types of physical durable storage media (as opposed to merely a propagated signal or mere energy). In particular, in some embodiments a configured storage medium 114 such as a portable (i.e., external) hard drive, CD, DVD, memory stick, or other removable nonvolatile memory medium becomes functionally a technological part of the computer system when inserted or otherwise installed, making its content accessible for interaction with and use by processor 110. The removable configured storage medium 114 is an example of a computer-readable storage medium 112. Some other examples of computer-readable storage media 112 include built-in RAM, ROM, hard disks, and other memory storage devices which are not readily removable by users 104. For compliance with current United States patent requirements, neither a computer-readable medium nor a computer-readable storage medium nor a computer-readable memory nor a computer-readable storage device is a signal per se or mere energy under any claim pending or granted in the United States.

The storage device 114 is configured with binary instructions 116 that are executable by a processor 110; “executable” is used in a broad sense herein to include machine code, interpretable code, bytecode, and/or code that runs on a virtual machine, for example. The storage medium 114 is also configured with data 118 which is created, modified, referenced, and/or otherwise used for technical effect by execution of the instructions 116. The instructions 116 and the data 118 configure the memory or other storage medium 114 in which they reside; when that memory or other computer readable storage medium is a functional part of a given computer system, the instructions 116 and data 118 also configure that computer system. In some embodiments, a portion of the data 118 is representative of real-world items such as events manifested in the system 102 hardware, product characteristics, inventories, physical measurements, settings, images, readings, volumes, and so forth. Such data is also transformed by backup, restore, commits, aborts, reformatting, and/or other technical operations.

Although an embodiment is described as being implemented as software instructions executed by one or more processors in a computing device (e.g., general purpose computer, server, or cluster), such description is not meant to exhaust all possible embodiments. One of skill will understand that the same or similar functionality can also often be implemented, in whole or in part, directly in hardware logic, to provide the same or similar technical effects. Alternatively, or in addition to software implementation, the technical functionality described herein can be performed, at least in part, by one or more hardware logic components. For example, and without excluding other implementations, some embodiments include one of more of: chiplets, hardware logic components 110, 128 such as Field-Programmable Gate Arrays (FPGAs), Application-Specific Integrated Circuits (ASICs), Application-Specific Standard Products (ASSPs), System-on-a-Chip components (SOCs), Complex Programmable Logic Devices (CPLDs), and similar components. In some embodiments, components are grouped into interacting functional modules based on their inputs, outputs, or their technical effects, for example.

In addition to processors 110 (e.g., CPUs, ALUs, FPUs, TPUs, GPUS, and/or quantum processors), memory/storage media 112, peripherals 106, and displays 126, some operating environments also include other hardware 128, such as batteries, buses, power supplies, wired and wireless network interface cards, for instance. The nouns “screen” and “display” are used interchangeably herein. In some embodiments, a display 126 includes one or more touch screens, screens responsive to input from a pen or tablet, or screens which operate solely for output. In some embodiments, peripherals 106 such as human user I/O devices (screen, keyboard, mouse, tablet, microphone, speaker, motion sensor, etc.) will be present in operable communication with one or more processors 110 and memory 112.

In some embodiments, the system includes multiple computers connected by a wired and/or wireless network 108. Networking interface equipment 128 can provide access to networks 108, using network components such as a packet-switched network interface card, a wireless transceiver, or a telephone network interface, for example, which are present in some computer systems. In some, virtualizations of networking interface equipment and other network components such as switches or routers or firewalls are also present, e.g., in a software-defined network or a sandboxed or other secure cloud computing environment. In some embodiments, one or more computers are partially or fully “air gapped” by reason of being disconnected or only intermittently connected to another networked device or remote cloud. In particular, mixed reality data stream analysis and device control facilitation functionality 204 could be installed on an air gapped network and then be updated periodically or on occasion using removable media 114, or not updated at all. Some embodiments also communicate technical data or technical instructions or both through direct memory access, removable or non-removable volatile or nonvolatile storage media, or other information storage-retrieval and/or transmission approaches.

One of skill will appreciate that the foregoing aspects and other aspects presented herein under “Operating Environments” form part of some embodiments. This document's headings are not intended to provide a strict classification of features into embodiment and non-embodiment feature sets.

One or more items are shown in outline form in the Figures, or listed inside parentheses, to emphasize that they are not necessarily part of the illustrated operating environment or all embodiments, but interoperate with items in an operating environment or some embodiments as discussed herein. It does not follow that any items which are not in outline or parenthetical form are necessarily required, in any Figure or any embodiment. In particular, FIG. 1 is provided for convenience; inclusion of an item in FIG. 1 does not imply that the item, or the described use of the item, was known prior to the current disclosure.

In any later application that claims priority to the current application, reference numerals may be added to designate items disclosed in the current application. Such items may include, e.g., software, hardware, steps, processes, systems, functionalities, mechanisms, data structures, computational resources, programming languages, tools, workflows, or algorithm implementations, or other items in a computing environment, which are disclosed herein but not associated with a particular reference numeral herein. Corresponding drawings may also be added.

### More About Systems

FIG. 2 illustrates a computing system 102 configured by one or more of the mixed reality data stream analysis and device control facilitation functionality enhancements taught herein, resulting in an enhanced system 202. In some embodiments, this enhanced system 202 includes a single machine, a local network of machines, machines in a particular building, machines used by a particular entity, machines in a particular datacenter, machines in a particular cloud, or another computing environment 100 that is suitably enhanced. FIG. 2 items are discussed at various points herein, and additional details regarding them are provided in the discussion of a List of Reference Numerals later in this disclosure document.

FIG. 3 shows some aspects of data flow in and around some enhanced systems 202. This is not a comprehensive summary of all aspects of enhanced systems 202 or all aspects of mixed reality data stream analysis functionality 204 and device control facilitation functionality 204. Device control facilitation functionality includes monitoring 816 for a response to a control action and updating 808 feedback accordingly. Nor is it a comprehensive summary of all aspects of an environment 100 or system 202 or other context of an enhanced system 202, or a comprehensive summary of any aspect of functionality 204 for potential use in or with a system 102. FIG. 3 items are discussed at various points herein, and additional details regarding them are provided in the discussion of a List of Reference Numerals later in this disclosure document.

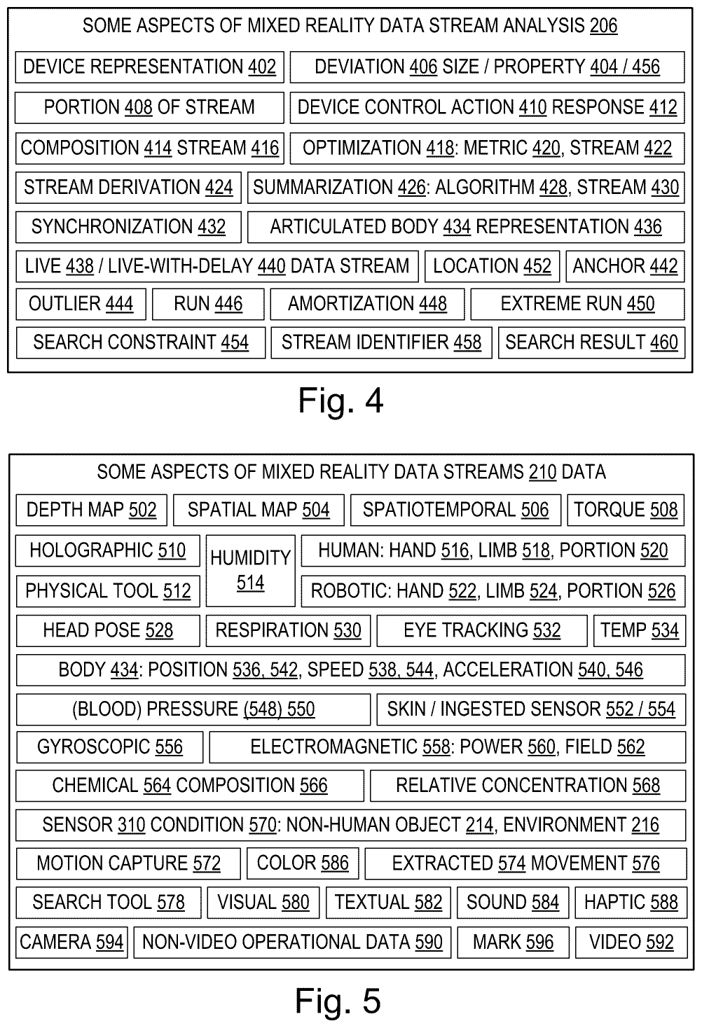

FIG. 4 shows some aspects of mixed reality data stream analysis 206. This is not a comprehensive summary of all aspects of mixed reality data stream analysis. FIG. 4 items are discussed at various points herein, and additional details regarding them are provided in the discussion of a List of Reference Numerals later in this disclosure document.

FIG. 5 shows some aspects of mixed reality data streams 210, 134. This is not a comprehensive summary of all aspects of any data stream 134. FIG. 5 items are discussed at various points herein, and additional details regarding them are provided in the discussion of a List of Reference Numerals later in this disclosure document.

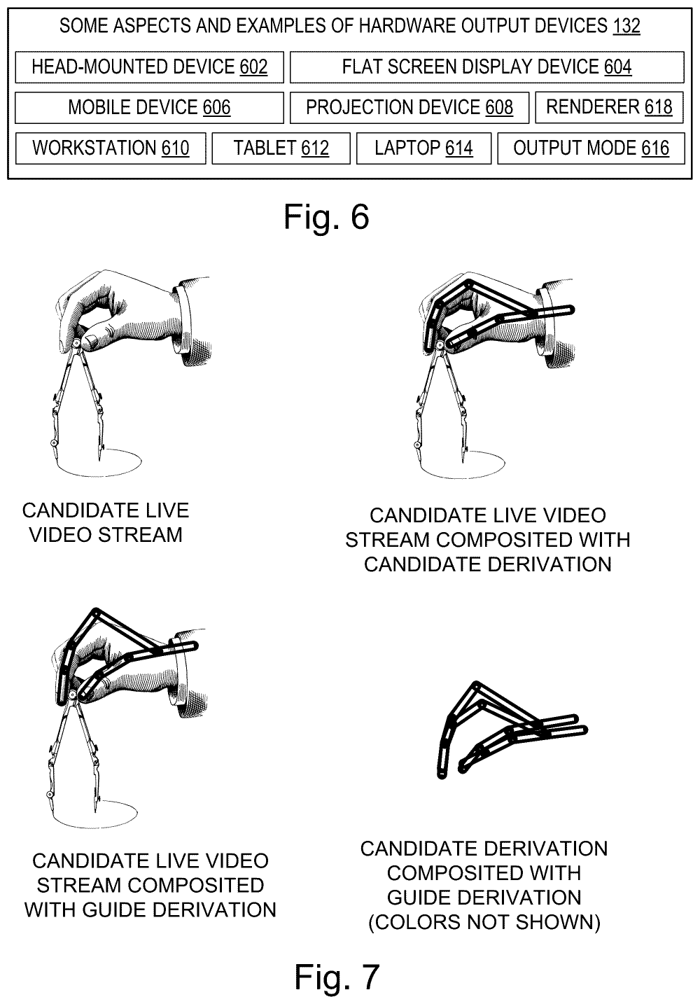

FIG. 6 shows some aspects and examples of hardware output devices 132. This is not a comprehensive summary of all aspects of any output device. FIG. 6 items are discussed at various points herein, and additional details regarding them are provided in the discussion of a List of Reference Numerals later in this disclosure document.

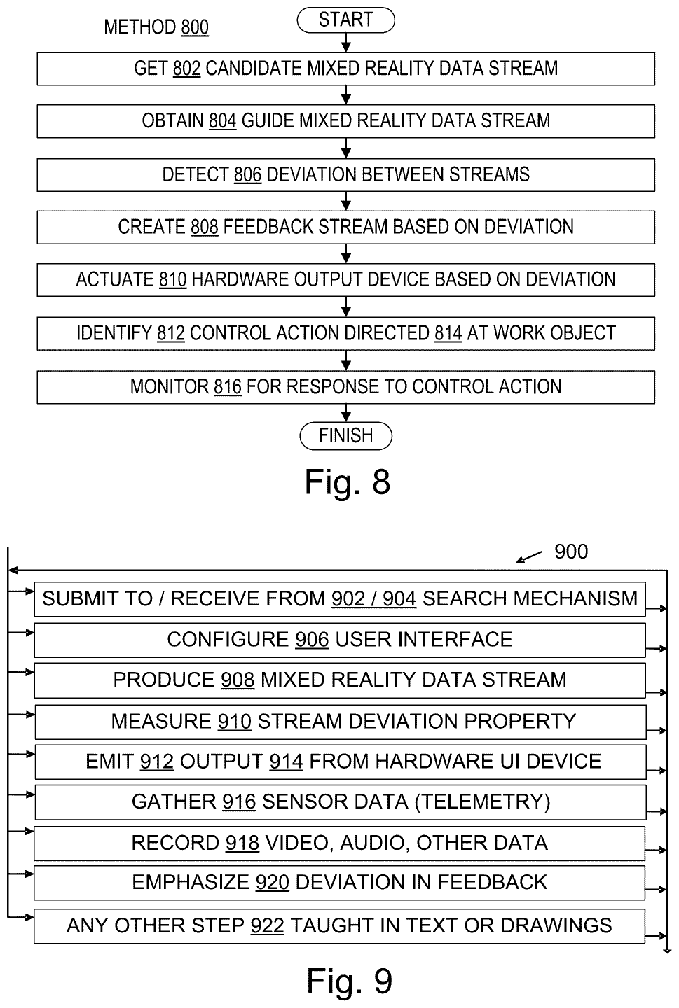

The other figures are also relevant to systems 202. FIG. 7 shows stylized depictions of output produced by some systems 202. FIGS. 8 and 9 illustrate methods of functionality 204 operation in systems 202.

The outputs shown in FIG. 7 are stylized because colors and video clips, for instance, are not amenable to full and photographic depiction in a patent disclosure line drawing. The FIG. 7 depictions are also stylized for clarity, e.g., user interface controls and surrounding environment details are not shown. Moreover, the handheld compass drawing tool depicted in the FIG. 7 drawings is only one of many tools and many machine parts (e.g., control panels, housing panels, internal components) that are susceptible to guided manipulation using an embodiment. Also, although a human hand is depicted manipulating the tool, in other scenarios a robotic hand serves as guide, or serves as candidate, or serves in both roles.

The FIG. 7 composited depictions also illustrate some embodiments in which the derivations are rendered as articulated bodies. In other embodiments or other scenarios, other renderings are employed. For example, in some cases live or near-live candidate video is composited with a guide video derivation to create a feedback stream in which a translucent guide hand overlays a photorealistic candidate hand. In some cases, the feedback stream shows a partially transparent guide hand overlaying a photorealistic candidate hand. In some cases, the feedback stream shows an outline of a guide hand overlaying a photorealistic candidate hand.

The FIG. 7 lower left and lower right depictions each show an example of a deviation. In this example deviation, the candidate's knuckles are positioned lower than the corresponding knuckle position in the guide stream. In the lower left depiction, an articulated body was extracted from the candidate live video but is not displayed; in the lower right depiction, the extracted candidate articulated body is displayed and the photorealistic hand video from which the candidate articulated body was extracted is not displayed. In each composited depiction case, an articulated body derived from the guide stream is displayed.

In the FIG. 7 lower left and lower right depictions, the example deviation is detected by a computational comparison of the positions of the candidate articulated body joints to the positions of the corresponding guide articulated body joints. The deviation is visually depicted in the feedback stream by compositing the renderings of the two streams or their derivatives. In some embodiments, color changes, supplemental audio (above any narration), and supplemental haptic output (above any already provided to the candidate) is also put in the feedback stream to emphasize the detected deviation.

In some embodiments, the enhanced system 202 is networked through an interface. In some, an interface includes hardware such as network interface cards, software such as network stacks, APIs, or sockets, combination items such as network connections, or a combination thereof.

Some embodiments include a computing system 202 which is configured to provide user guidance about controlling a real-world device, the user guidance based on an analysis of digital mixed reality data streams. The computing system includes: a digital memory 112, a user interface 124 including at least one hardware output device 132, and a processor set 110 including at least one processor, the processor set in operable communication with the digital memory and the user interface. The system 202 also includes a guidance forge 306. The guidance forge 306 is or includes software, or a software hardware combination, which creates a feedback stream from two or more input streams that include mixed reality data. The guidance forge is configured to, upon execution by the processor set, detect 806 a deviation 406 between a candidate mixed reality data stream 210 and a guide mixed reality data stream 210, at least one of the mixed reality data streams including a digital representation 402 of the real-world device 214, create 808 a feedback stream 308 based at least in part on the deviation, and actuate 810 the user interface hardware output device 132 according to at least a portion of the feedback stream. In some embodiments, the user interface hardware output device 132 is configured to emit 912 an output 914 which includes or is otherwise based on at least one of: visual data 580, textual data 582, sound data 584, color data 586, or haptic data 588.

In some embodiments, deviation detection 806 utilizes an adaptation of a flight path deviation detection algorithm, which is adapted from aircraft path monitoring for use in comparisons of mixed reality data streams. In some embodiments, deviation detection 806 utilizes an adaptation of an indoor navigation path deviation detection algorithm, which is adapted from monitoring paths of visually impaired persons for use in comparisons of mixed reality data streams. In some embodiments, robotic movement algorithms, or SLAM (simultaneous localization and mapping) algorithms, or other sensor-based location detection and mapping algorithms are adapted for deviation detection 806. Adaptation of these or some other path deviation detection technology includes identifying a core deviation computation procedure and configuring that procedure to receive and process non-video operational data from the data streams instead of processing avionics telemetry or robotic telemetry or predefined locations in a facility for the visually impaired, for example. In some embodiments, a deviation computation procedure 806 performs anomaly detection, based on statistical measures or using a trained machine learning model, for example.

In some embodiments, the guidance forge 306 is configured to, upon execution by the processor set, measure 910 a size 404 of the deviation, create 808 the feedback stream based at least in part on the size of the deviation, and actuate 810 the user interface hardware output device according to at least the size of the deviation.

In some embodiments, the guidance forge 306 is configured to, upon execution by the processor set, create 808 the feedback stream at least in part by computationally compositing 414 a guide derivation 424, 134 of the guide mixed reality data stream over a candidate derivation 424 of the candidate mixed reality data stream. A derivation of a first data stream 134 is a second data stream 134 which is computationally based at least in part on at least a portion of the first data stream (“first” and “second” are used here solely to distinguish between streams, not to impose timing). In some of these embodiments, the guide derivation is at least one of: translucent 616, partially transparent 616, displayed as an outline 616, displayed as a skeleton 616, or visually blocking less than one third of the candidate derivation 616. The foregoing display options are collectively referred to herein as hardware output device modes 616, a.k.a. output modes 616. Particular modes, namely the translucent, partially transparent, outline, and articulated body 434 skeleton output modes (but not the less than a third blocked mode) are also referred to herein as ghost modes.

In some embodiments, at least one of the mixed reality data streams includes an anchor, and the anchor corresponds to at least one of: a work object 212, or a physical real-world location 452. A work object 212 is a real or virtual object which is an actual or attempted target of a control action 410. A control action 410 is a command, movement, or other action to control a device or an object. In particular, some embodiments utilize an anchor produce by a mixed reality solution such as a Microsoft Guides™ solution, or Azure® spatial anchors or Azure® object anchors (marks of Microsoft Corporation). A technical benefit of anchors in two or more streams is that they facilitate positional synchronization of the two or more streams; the anchors serve as a shared reference point, or serve as an origin in a shared coordinate system.

In some embodiments, at least one of the mixed reality data streams includes at least one of the following kinds of non-video operational data: depth map data 502, spatial map data 504, or holographic data 510.

In some embodiments, at least one of the mixed reality data streams includes a digital articulated body 434 representation 436 which digitally represents at least one of: a human hand 516, a human limb 518, at least a portion 520 of a human body, a robotic hand 522, a robotic limb 524, at least a portion 526 of a robotic mechanism, a manually operable non-powered physical tool 512 other than a software tool 122, or a powered physical tool 512 other than a software tool 122.

In some embodiments, the articulated body representation 436 is computed according to an algorithm for skeleton extraction from images. In some embodiments, a skeleton extraction computation utilizes one or more of: embedded topological graphs, computational geometry, example poses, mesh contraction, curve skeleton extraction, skeleton linking, and a machine learning model trained on data such as images, edge detection results, and corresponding articulated body representations.

In some embodiments, at least one of the mixed reality data streams includes at least one of: head pose (a.k.a. head tracking) data 528, eye tracking data 532, articulated body position data 536, articulated body speed data 538, articulated body acceleration data 540, respiration data 530, blood pressure data 548, living body temperature data 534, skin sensor data 552, or ingested sensor data 554.

For example, some embodiments include head pose 528 and eye gaze data 532 from eye tracking or head tracking cameras. This data facilitates determination of what an expert or other guide is looking at, and how they are positioning the rest of their body to perform an operation 314.

In some embodiments, at least one of the mixed reality data streams includes at least one of: spatiotemporal data 506 (e.g., real-time spatial data), speed data 544 other than articulated body speed data 538, acceleration data 546 other than articulated body acceleration data 540, gyroscopic data 556, pressure data 550 other than blood pressure data 548, torque data 508, temperature data 534 other than living body temperature data, humidity data 514, electromagnetic power data 560, electromagnetic field data 562, chemical composition data 566 (“chemical” encompasses pharmacological and biological for present purposes), relative concentration data 568, sensor 310 data 304 representing a real-world non-human object 214 physical condition 570, or sensor data 304 representing a real-world environment 216 physical condition 570.

In some embodiments, the hardware output device 132 includes or resides within at least one of: a head-mounted device 602, a mobile device 606, a flat screen display device 604, 126, a projection device 608, 126, a laptop 614, 102, a tablet 612, 102, or a workstation 610, 102.

Other system embodiments are also described herein, either directly or derivable as system versions of described processes or configured media, duly informed by the extensive discussion herein of computing hardware.

Although specific mixed reality data stream analysis and device control facilitation architecture examples are shown in the Figures, an embodiment may depart from those examples. For instance, items shown in different Figures may be included together in an embodiment, items shown in a Figure may be omitted, functionality shown in different items may be combined into fewer items or into a single item, items may be renamed, or items may be connected differently to one another.

Examples are provided in this disclosure to help illustrate aspects of the technology, but the examples given within this document do not describe all of the possible embodiments. A given embodiment may include additional or different kinds of mixed reality data stream analysis functionality, or device control facilitation functionality, or both, for example, as well as different technical features, aspects, mechanisms, software, expressions, operational sequences, commands, data structures, programming environments, execution environments, environment or system characteristics, or other functionality consistent with teachings provided herein, and may otherwise depart from the particular examples provided.

### Processes (a.k.a. Methods)

Processes (which are also be referred to as “methods” in the legal sense of that word) are illustrated in various ways herein, both in text and in drawing figures. FIGS. 8 and 9 each illustrate a family of methods 800 and 900 respectively, which are performed or assisted by some enhanced systems, such as some systems 202 or another mixed reality data stream analysis functionality enhanced system or device control facilitation functionality enhanced system as taught herein. Device control facilitation functionality includes monitoring 816 for a response 412 to control actions 410 and updating 808 feedback accordingly. Method family 800 is a proper subset of method family 900.

Some variations on FIG. 8 exclude getting 802 the candidate stream, obtaining 804 the guide stream, or both, but instead proceed to analyze 806, 808 streams already gotten or already obtained. Some variations on FIG. 8 exclude identifying 812 a control action per se but nonetheless monitor 816 items for responses to actions, whether they are control actions or actions caused, e.g., by operation of a work object or other machine in the real-world environment. Some variations on FIG. 8 detect 806 deviations among three or more streams 134 which include at least one candidate stream 210 and at least one guide stream 210. These are merely examples of variations; as noted elsewhere, any operable combination of steps that are disclosed herein may be part of a given embodiment.

FIGS. 1 to 7 illustrate mixed reality data stream analysis system 202 architectures with implicit or explicit actions within a computing system, e.g., communicating with a guidance forge 306 API, computationally receiving, forwarding, storing, retrieving, sampling, or summarizing electronic sensor 310 data (a.k.a. telemetry), receiving data via user interface input devices 130, executing login and authentication operations, mapping data to an articulated body representation 436, or otherwise processing data 118, in which the data 118 includes, e.g., data streams 134, virtual work objects 212, representations 402 of real-world work objects 212, sensor data 304, digital representations of real-world environments 216, and communications with APIs which interface electronically with hardware output devices 132, among other examples disclosed herein.

Technical processes shown in the Figures or otherwise disclosed will be performed automatically, e.g., by an enhanced system 202, unless otherwise indicated. Related non-claimed processes may also be performed in part automatically and in part manually to the extent action by a human person is implicated, e.g., in some situations a human 104 types a command or speaks a command in a natural language, or moves a joystick or other controller, in each case to control a work object, any of which activities is captured in the system 202 digitally as a control action 410. Natural language means a language that developed naturally, such as English, French, German, Hebrew, Hindi, Japanese, Korean, Spanish, etc., as opposed to designed or constructed languages such as programming languages.

Regardless, no process contemplated as an embodiment herein is entirely manual or purely mental. None of the claimed processes can be performed solely in a human mind or on paper. Human activity per se is not claimed and is hereby expressly disclaimed. Any claim interpretation to the contrary is squarely at odds with the present disclosure and therefore is not a reasonable interpretation.

In a given embodiment zero or more illustrated steps of a process may be repeated, perhaps with different parameters or data to operate on. Steps in an embodiment may also be done in a different order than the top-to-bottom order that is laid out in FIG. 9. FIG. 9 is a supplement to the textual examples of embodiments provided herein and the textual descriptions of embodiments provided herein. In the event of any alleged inconsistency, lack of clarity, or excessive breadth due to an aspect or interpretation of FIG. 9, the text of this disclosure shall prevail over that aspect or interpretation of FIG. 9.

Arrows in process or data flow figures indicate allowable flows; arrows pointing in more than one direction thus indicate that flow may proceed in more than one direction. Steps may be performed serially, in a partially overlapping manner, or fully in parallel within a given flow. In particular, the order in which flowchart 900 action items are traversed to indicate the steps performed during a process may vary from one performance instance of the process to another performance instance of the process. The flowchart traversal order may also vary from one process embodiment to another process embodiment. Steps may also be omitted, combined, renamed, regrouped, be performed on one or more machines, or otherwise depart from the illustrated flow, provided that the process performed is operable and conforms to at least one claim of an application or patent that includes or claims priority to the present disclosure. To the extent that a person of skill considers a given sequence S of steps which is consistent with FIG. 9 to be non-operable, the sequence S is not within the scope of any claim. Any assertion otherwise is contrary to the present disclosure.

Some embodiments provide or utilize a method 900 of analyzing mixed reality data streams based on controlling a real-world device, the method 900 being performed by a computing system 202. In this discussion and generally elsewhere herein, “method” is used in the legal sense and “process” is used in the computer science sense. This method 900 includes automatically at least: getting 802 a candidate mixed reality data stream; obtaining 804 a guide mixed reality data stream, at least one of the mixed reality data streams including a digital representation of the real-world device; computationally detecting 806 a deviation between the candidate mixed reality data stream and the guide mixed reality data stream; computationally creating 808 a feedback stream based at least in part on the deviation; and actuating 810 a user interface hardware output device according to at least a portion of the feedback stream.

In some embodiments, the method further includes: identifying 812 in at least one of the mixed reality data streams a digital representation of a control action which is directed at the real-world device; and monitoring 816 the real-world device for a response to the control action.

In some embodiments, the method includes: submitting 902, to a search mechanism 578 (a.k.a. search tool), a search constraint 454 and an identifier 458 of at least one of the mixed reality data streams to be searched based on at least the search constraint; receiving 904 a search result 460 from the search mechanism; and configuring 906 a user interface 124 according to at least a portion of the search result.

In some embodiments, the method includes computationally producing 908 at least a portion of at least one of the mixed reality data streams 210. This includes, e.g., recording, gathering, capturing, extracting, compositing, and other computational activity discussed herein

In some embodiments, the method includes computationally synchronizing 432 respective portions 408 of at least two of the mixed reality data streams for presentation 906 in the user interface. In some embodiments, this includes one or more of: audio-video synchronization using an audio-video synchronization algorithm, frame synchronization to a synchronization signal, feature-based multi-video synchronization, motion-based video synchronization, or real-time adaptive content-based synchronization.

In some embodiments, the method includes at least one of: computationally generating 418 an optimization stream 422 based on at least an optimization metric 420 and at least a portion 408 of each of the mixed reality data streams; computationally making 426 a summarization stream 430 based on at least a summarization algorithm 428 and at least a portion 408 of each of the mixed reality data streams; computationally forming 414 a composition stream 416 by compositing 414 at least a portion 408 of each of the mixed reality data streams.

In some embodiments, the optimization stream is or includes a data stream which is an optimization of a measurement of time, an optimization of a deviation size or other property, an optimization of a user satisfaction per survey results, or an optimization of another measurable characteristic of a stream 134 which is associated with an optimization 418 effort. For example, a stream which is a concatenation of the fastest segments selected from a set of streams is an optimization stream. Likewise, a stream which is a concatenation of the smallest-deviation segments selected from a set of streams is an optimization stream.

In some embodiments, the summarization stream is or includes a data stream which is a summarization of a measurement of time, a summarization of a deviation size or other property, a summarization of a user satisfaction per survey results, or a summarization of another measurable characteristic of a stream 134 which is associated with a summarization effort. For example, a stream which is a concatenation of keyframes (with neighboring frames being omitted) from a set of streams is a summarization stream. Likewise, a stream which is a result of a command to a trained machine learning model to summarize a stream or to summarize a set of streams is a summarization stream.

Some embodiments provide or utilize a method of analyzing mixed reality data streams to facilitate control of a real-world device, the method including automatically: getting a first mixed reality data stream including a stream of sensor data, or data derived from sensor data, depicting a candidate user operating the real-world device; obtaining a second mixed reality data stream, including a stream of sensor data, or data derived from sensor data, depicting an operation which operates the real-world device; computationally detecting a deviation between the candidate mixed reality data stream and the guide mixed reality data stream, e.g., by finding a difference between a single frame in each stream; computationally creating a feedback stream based at least in part on the deviation which provides instructional feedback, wherein the feedback stream includes, for each of a plurality of frames of the feedback stream, an indication of how the candidate user can match the operation depicted in the guide stream; and actuating a user interface hardware output device according to at least a portion of the feedback stream.

### Configured Storage Media

Some embodiments include a configured computer-readable storage medium 112. Some examples of storage medium 112 include disks (magnetic, optical, or otherwise), RAM, EEPROMS or other ROMs, and other configurable memory, including in particular computer-readable storage media (which are not mere propagated signals). In some embodiments, the storage medium which is configured is in particular a removable storage medium 114 such as a CD, DVD, or flash memory. A general-purpose memory, which is be removable or not, and is volatile or not, depending on the embodiment, can be configured in the embodiment using items such as mixed reality data streams 210, work objects 212, telemetry 304, a guidance forge 306, feedback streams 308, search constraints 454, communications with output devices 132, articulated body representations, and ghost mode 616 data, in the form of data 118 and instructions 116, read from a removable storage medium 114 and/or another source such as a network connection, to form a configured storage medium. The configured storage medium 112 is capable of causing a computer system 202 to perform technical process steps for providing or utilizing mixed reality data stream analysis and device control facilitation functionality 204 as disclosed herein. The Figures thus help illustrate configured storage media embodiments and process (a.k.a. method) embodiments, as well as system and process embodiments. In particular, any of the method steps illustrated in FIG. 3, 7, 8 or 9, or otherwise taught herein, may be used to help configure a storage medium to form a configured storage medium embodiment.

Some embodiments use or provide a computer-readable storage device 112, 114 configured with data 118 and instructions 116 which upon execution by a processor 110 cause a computing system 202 to perform a method 900 of providing 906 user guidance about controlling a real-world device, the user guidance based on an analysis 806, 808 of digital mixed reality data streams. This method 900 includes: detecting 806 a deviation between a candidate mixed reality data stream and a guide mixed reality data stream, at least one of the mixed reality data streams including a digital representation of the real-world device; creating 808 a feedback stream based at least in part on the deviation; and actuating 810 a user interface hardware output device according to at least a portion of the feedback stream.

In some embodiments, the candidate mixed reality data stream 210 includes a live 438 video stream 134 or a live-with-delay 440 video stream 134. Herein live-with-delay 440 video, also referred to as deferred live video, includes video with a delay no longer than the propagation time from video source to video display device plus thirty seconds.

In some embodiments, creating 808 the feedback stream includes compositing 414 multiple data streams 134.

In some embodiments, the method includes searching 902 and 904 a data stream 134 for at least one of: an outlier 444, a lowest deviation run 450, a greatest deviation run 450, or an amortized analysis result 448.

In some embodiments, the method includes producing 908 at least one of the mixed reality data streams, and the producing includes at least one of: capturing 572 motion data 576, extracting 574 movement data 576 from a video 302, or gathering 916 sensor telemetry data 304.

### Additional Observations

Additional support for the discussion of mixed reality data stream analysis functionality 204 and device control facilitation functionality 204 herein is provided under various headings. However, it is all intended to be understood as an integrated and integral part of the present disclosure's discussion of the contemplated embodiments.

One of skill will recognize that not every part of this disclosure, or any particular details therein, are necessarily required to satisfy legal criteria such as enablement, written description, best mode, novelty, nonobviousness, inventive step, or industrial applicability. Any apparent conflict with any other patent disclosure, even from the owner of the present subject matter, has no role in interpreting the claims presented in this patent disclosure. With this understanding, which pertains to all parts of the present disclosure, examples and observations are offered herein.

Some embodiments speed up training of workers, and some encode institutional knowledge in durable yet flexible formats. Some embodiments reduce or even prevent workplace injury. Some embodiments address challenges which arise in industries in which a manufacturing workforce is getting older and a large percentage of skilled workers are nearing retirement age. These embodiments help prevent or reduce an otherwise huge loss of workplace wisdom for many companies, by providing a fast and reliable method of recording and then effectively presenting that knowledge. In addition to capturing workplace wisdom, the training provided through some embodiments allows for proper execution of tasks, to reduce human error and mitigate ergonomic issues. By utilizing these embodiments, companies are able to quickly upskill new workers to do a documented job 314 quickly, accurately, and efficiently. Many of these jobs require manual dexterity and specific movements to achieve the best results, so written manuals or conventional videos (i.e., a sequence of images plus optional audio plus optional timecodes) are often not optimal training mechanisms.

Some embodiments provide or utilize a method 900 of recording 918 such workplace knowledge using HoloLens® devices or other head-mounted devices (HMD) 602 which contain hand-tracking cameras. In some scenarios, multiple people each wear an HMD and participate together in a shared session from different physical geographical locations. HMD cameras allow the HMD to create an accurate pose of one or both hands of the HMD user, including the finger joints, which are tracked at high frequency. Some embodiments provide or utilize a recording and playback mechanism which allows the user's hand and finger movements 576 to be recorded in the context of doing a specific task 314. These recordings 918 are mapped to the specific task 314 in a work-management tool 122 or training software application 122 such as Microsoft Dynamics 365 Guides™ (mark of Microsoft Corporation). In some scenarios, voice recordings are also taken and synchronized 432 with the hand movements to provide a more complete training experience.

Once recorded, a digital representation 576 of hand movements of an expert becomes a part of the task 314 description. The software 306 then re-renders the hand movements on demand using a transparent or translucent rendering shader 618, to allow new users using the HMD and training software to mimic and learn the specific movements of the expert while performing the task 314 themselves. In some scenarios, the expert hands appear in a display 126 rendering like an expert ghost, leading a new user (candidate) through the task 314, with the nuances of the expert's approach captured digitally and presented 906 to help the new user achieve the best results.

Some embodiments record hand and tool movements 576 for later comparison and playback. These are not mere video 592 recordings, but are instead recorded augmented reality representations 436 of physical placement, arm, finger, and tooling positions along with speed and acceleration data. Accordingly, as viewpoints change, the stream 308, 134 displayed data presentation moves with the user. As a head changes viewpoints, or someone turns or moves, all the data remains properly anchored and moves as it would if the recorded viewpoint had moved in the actual recorded reality.

By including within a data stream 134 non-video operational data 590 such as sensor data 304, spatial map data 504, positioning data 506 such as gyroscopic data 556, or other data 590 which is not present in a mere video 592 recording, an embodiment enhances the flexibility and scope of use of the data stream. Some embodiments utilize non-video operational data 590 to reproduce a portion of the guide objects or guide environment in a different live or simulated environment. For example, in one scenario a target machine 212 is positioned differently in a candidate environment than it was positioned in the guide environment.

Non-video operational data 590 supports recording relative to a machine position or a machine orientation rather than a fixed position. In one scenario, the non-video operational data supports different candidate display camera positions. A movable zoomable virtual camera 594 allows the display of a button pushes and other hand movements, and hand position, from different perspectives in the feedback stream. In another scenario, a virtual representation of a different model of a machine 212 is swapped in, so the feedback stream shows operations on the swapped-in model even though the movements in the feedback are based on the machine's original model 212 which was utilized during the recording of the guide stream.

In some scenarios and embodiments, the data stream 134 is played back in a ghost mode 616 showing how a previous person did the particular job. This ghost mode overlays 414 a particular live run, or overlays 414 a different recorded run.

In some scenarios and embodiments, haptic feedback 588 is provided when alignment between the current user and the ghost mode guide is not right. In some, a noise 584 is played when (for example) all the tools 512 are in the right spots according to the guide.

In some scenarios and embodiments, capability to search 902, 904 is provided. For example, in some a capability is provided to search based on a constraint 454 such as “How did a previous person do this?” In some scenarios and embodiments, supported search constraints correspond to questions such as “How did an expert do it?”, “How did the last person who tried this task do this task?”, and “How did I do this job last year compared to this year?”

Some embodiments provide or utilize a method of augmenting visual data 580, the method including: (a) obtaining 804 first visual data; (b) computing a digital representation 436 of a limb and a digital representation of placements 576 of the limb over time, the representations based on at least the first visual data, the digital representation of the limb representing the limb in at least three spatial dimensions at a given point in time; (c) recording 918 the representations; (d) playing 906 a visual rendering 580 which is based on at least a portion of the recorded representations; and (e) compositing 414 the visual rendering with second visual data, thereby (f) producing a visual comparison 308 of a first activity which occurred while obtaining the first visual data to a second activity which occurs or occurred during the playing of the visual rendering.

Although many guide streams 210 will include video 592, video is not always required. That is, video is only one format in which an original live stream reference can be sourced. An alternative in some variations is spatial map information 504 which represents expert movements 576. In other words, it is possible to capture a reference guide stream of expert movement without relying on video recording. Some embodiments capture a reference guide stream of expert movement based purely on hand tracking information, utilizing a spatial anchor to measure movements. That is, hand motion is captured per a two-dimensional scannable code, bar code, or other anchor, as a basis for creating a ghost mode hand, without reliance on other information about the spatial environment.

Some embodiments provide or utilize a method of generating 908 a mixed reality instructional data stream 308, the method including automatically: getting 802 a live stream which includes video 592; obtaining 804 a recorded stream which includes an articulated body representation 436 of operational data 590; comparing 806 a derivative 424 of the live stream with the recorded stream; creating a feedback stream 308 based at least in part on a result of the comparing; compositing 414 the live stream with the feedback stream, thereby making a composition; and configuring 906 a display with the composition.

In some variations, the comparison isn't necessarily against a live stream 134. For example, in one scenario a user records themself repairing a condenser, and then compares that recorded stream against a reference recording 210 of a Master Tech doing the same repair task 314.

In some variations, a feedback stream 308 is a distinct stream, and in some the feedback stream is a composite 414 built up over multiple streams.

In many embodiments and scenarios, the activity recording 210 includes more than video image data 592. In some, the activity recording includes sensor data 304, three-dimensional mappings 504, depth maps 502, stereo audio 584, or other data 118 noted herein.

In many embodiments, the method configures 906 a display 126 of at least one of: a head-mounted device 602, a mobile device 606, a flat screen display device 604, a laptop 614, a tablet 612, or a workstation 610. In some cases, the display includes hardware 132 for emitting audio or presenting a user with other multi-modal data, e.g., haptic output.

In some embodiments, a display presentation 906 to a user is based on an articulated body representation 436 which digitally represents at least one of: a human hand, a human arm, a robotic hand, a robotic arm, or a hand tool. A “hand tool” (a.k.a. “tooling”) is a physical tool 512 or a virtual tool 122 digital representation of a physical tool which is built to be gripped by at least one hand and capable of being positioned by one or more hands (human or robotic). Some hand tools are powered, e.g., an electric drill, while other hand tools are not powered, e.g., a bubble level.

In some scenarios, hand tool control 410 is based on information provided to a user by a head mounted display in a First Person View (FPV) perspective. In some cases, a hand tool is controlled 410 by using one hand, and in some cases a hand tool is controlled 410 by using two hands. Indeed, in some cases a hand tool is controlled 410 by using more than two hands, e.g., by hands of multiple participants in a video conference call.

In some cases, the perspective on which a display output is based is controlled separately from a hand tool. For example, in some embodiments and scenarios, a physical or virtual camera 594 producing a stream 134 pans, zooms in or zooms out, or moves relative to an anchor such as a work object.

In some embodiments, a display presentation 906 to a user is based on an articulated body representation has associated operational data 590 which includes at least one of the following pertaining to the articulated body or its environment or a work object or a combination thereof: spatiotemporal data, speed data, acceleration data, pressure data, torque data, temperature data, electromagnetic power data, or electromagnetic field data. In some scenarios, an articulated body representation 436 with associated operational data 590 provides instructional data about joint movement, which helps a candidate understand how a guide hand moved. For example, the difference between a turn to the right and a turn to the left to screw on a widget, or other information about a direction of movement of an object, is sometimes clarified by using depictions of an articulated body 434.

In some variations, the articulated body representation operational data stream 210 includes or is supplemented with non-video operational data 590 including sensor data, e.g., oxygen percentage, humidity, carbon monoxide ppm (parts per million), and so on. For instance, in one scenario a candidate is doing welding in an argon (inert gas) environment using robotic arms, and the data stream(s) 210 include gas pressure, temperature, and telemetry from detectors that are monitoring for contamination of the environment by a non-inert gas.

In some embodiments and scenarios, a recorded stream 134 includes an anchor 442. In some embodiments and scenarios, the anchor 442 corresponds to a work object, e.g., a machine containing a widget. The work object 212 is physical in some scenarios and holographic in some scenarios. In some embodiments and scenarios, the anchor corresponds to a physical world location 452, e.g., a benchtop position marked by a scannable two-dimensional printed code.

In some embodiments and scenarios, a feedback stream 308 includes at least one of: haptic data, color data, sound data, ink stroke data, or textual data. In some variations, the feedback stream includes or is supplemented with metadata or other non-video operational data 590, e.g., data representing real-world phenomena, such as data tracking blood pressure, respiration rate, pulse rate, blood oxygen level, eye movement tracking, and other sensor data.

In some embodiments and scenarios, a data stream 210 is searchable by at least one of the following constraints 454: keyword, date, tag, or articulated body ID. In some scenarios, a data stream is searchable for a specified person's outliers, their best runs, their amortized runs, or other variations of composited runs.

Some embodiments provide or utilize tools and techniques for producing 908 a data stream 134. In some cases, this includes video or audio recording, or both. In some cases, producing 908 a data stream includes motion capture 572 or movement extraction 574 from video. In some cases, producing a data stream includes gathering sensor telemetry. In particular, in some cases sensor telemetry 304, 590 is computationally transformed to produce an articulated body representation with operational data. In some cases, a stream is recorded by cameras or gyroscopic sensors on a head-mounted device, or recorded from fixed cameras observing the user, or both.

Some embodiments facilitate candidate training or other performance improvement. Candidates get better at doing a task 314 by looking at how their own actions compare to a guide's reference actions. A visual overlay such as in ghost mode helps even if deviations are not emphasized in a feedback stream.

However, emphasizing 920 deviations via visual, audio, or haptic highlighting is sometimes very helpful. For example, in some embodiments and scenarios, human-perceptible feedback is emitted 912 around a deviation in real time, such as a buzz, a sound, or a color overlay each time a candidate movement deviates from the guide movement. In one example, the UX indicates 912 by green coloring that everything in the correct position according to the guide, and any deviation is shown in red. In some variations, the color change or other perceptible feedback is automatically based on the size of the deviation, e.g., using a color gradient between green and red, a sound repetition speed (analogous to a Geiger counter output), a sound volume, a haptic vibration speed, or a haptic vibration magnitude. Some embodiments provide multisensory feedback 308, e.g., color and sound.

Some embodiments support analysis of multiple streams 134 to search for optimization opportunities. For example, assume several candidate streams are marked to delimit portions corresponding to identified steps in a task 314. Marking 596 may include identifying keyframes, listing timecodes, or listing durations as offsets from a base, for example. Then comparison of the respective durations of corresponding portions of the several candidate streams reveals where time is being gained or lost.

In some embodiments and scenarios, a composite optimal stream is formed by adjoining the best of the stream portions, e.g., a fastest step A from a stream ID3, a fastest step B from a stream ID2, a fastest step C from a stream ID1, and a fastest step D from the stream ID2, to form a composite optimal stream that shows performance of the steps A, B, C, D in that order. In some variations, the optimized stream data property is not speed but is instead, e.g., lowest number of deviations from a specified guide stream, smallest deviation from the specified guide stream, or smallest cumulative size of deviations from the specified guide stream.

Although in many scenarios the guide shows a desired, best, or ideal way to perform a task 314, in some scenarios at least a portion of a guide shows a bad example. That is, the guide shows what to avoid, rather than showing what to emulate. Some guides show both good examples and bad examples. For instance, in one scenario a guide shows an example of how to lift a heavy work object, and the guide also shows an example of how not to lift the heavy work object, in order to avoid harm to a person or damage to the work object or both.

### Internet of Things

In some embodiments, the system 202 is, or includes, an embedded system such as an Internet of Things system. “IoT” or “Internet of Things” means any networked collection of addressable embedded computing or data generation or actuator nodes. An individual node is referred to as an internet of things device 101 or IoT device 101 or internet of things system 102 or IoT system 102. Such nodes are examples of computer systems 102 as defined herein, and may include or be referred to as a “smart” device, “endpoint”, “chip”, “label”, or “tag”, for example, and IoT may be referred to as a “cyber-physical system”. In the phrase “embedded system” the embedding referred to is the embedding a processor and memory in a device, not the embedding of debug script in source code.

IoT nodes and systems typically have at least two of the following characteristics: (a) no local human-readable display; (b) no local keyboard; (c) a primary source of input is sensors that track sources of non-linguistic data to be uploaded from the IoT device; (d) no local rotational disk storage-RAM chips or ROM chips provide the only local memory; (e) no CD or DVD drive; (f) being embedded in a household appliance or household fixture; (g) being embedded in an implanted or wearable medical device; (h) being embedded in a vehicle; (i) being embedded in a process automation control system; or (j) a design focused on one of the following: environmental monitoring, civic infrastructure monitoring, agriculture, industrial equipment monitoring, energy usage monitoring, human or animal health or fitness monitoring, physical security, physical transportation system monitoring, object tracking, inventory control, supply chain control, fleet management, or manufacturing. IoT communications may use protocols such as TCP/IP, Constrained Application Protocol (CoAP), Message Queuing Telemetry Transport (MQTT), Advanced Message Queuing Protocol (AMQP), HTTP, HTTPS, Transport Layer Security (TLS), UDP, or Simple Object Access Protocol (SOAP), for example, for wired or wireless (cellular or otherwise) communication. IoT storage or actuators or data output or control may be a target of unauthorized access, either via a cloud, via another network, or via direct local access attempts.

### Technical Character

The technical character of embodiments described herein will be apparent to one of ordinary skill in the art, and will also be apparent in several ways to a wide range of attentive readers. Some embodiments address technical activities such as computationally detecting 806 deviations using anomaly detection or path deviation algorithms, actuating 810 hardware devices based on a data stream 134, 308, gathering 916 sensor telemetry data, compositing 414 data streams, creating digital representations 436 of articulated bodies 434, configuring 906 user interfaces, and rendering 618 a translucent or partially transparent image of a video recording, which are each an activity deeply rooted in computing technology. Some of the technical mechanisms discussed include, e.g., cameras 594, head-mounted devices 602, computational guidance forges 306, sensors 310, and image renderers 618. Some of the technical effects discussed include, e.g., creation of a feedback stream 308 which visually compares candidate actions to guide actions, supplemented in some scenarios with audio or haptic results of the comparison, feedback streams 308 which emphasize 920 deviations in accordance with deviation size 404, and creation of composite 414 mixed reality data streams 210. Thus, purely mental processes and activities limited to pen-and-paper are clearly excluded. Other advantages based on the technical characteristics of the teachings will also be apparent to one of skill from the description provided.

One of skill understands that data stream 134 operations generally are technical activities which cannot be performed mentally, because they require altering the state of computing system memory 112. As disclosed herein, data stream 134 analysis and utilization operations involve computational activities such as video recording, video playback, comparison of data streams, gathering sensor data, compositing images, rendering images, and actuating hardware devices, which cannot be performed mentally or manually. One of skill also understands that attempting to perform data stream 134 analysis 206 even in part manually would create unacceptable delays and introduce human errors that one of skill would consider unacceptable if given the alternative of using technology described herein. People manifestly lack the speed, accuracy, memory capacity, electronic communication, and specific processing capabilities required to perform data stream 134 analysis 206.

In particular, operations on data streams 134 as described herein are a part of computing technology. Hence, the data stream analysis and device control facilitation improvements of functionality 204 described herein are improvements to computing technology.

Different embodiments provide different technical benefits or other advantages in different circumstances, but one of skill informed by the teachings herein will acknowledge that particular technical advantages will likely follow from particular embodiment features or feature combinations, as noted at various points herein. Any generic or abstract aspects are integrated into a practical application such as a remote assistance solution, e.g., Microsoft Dynamics 365® Guides, which is a mixed-reality application for Microsoft HoloLens® devices that helps headset operators by providing helpful holographic instructions (marks of Microsoft Corporation).

Some embodiments described herein may be viewed by some people in a broader context. For instance, concepts such as efficiency, reliability, user satisfaction, or waste may be deemed relevant to a particular embodiment. However, it does not follow from the availability of a broad context that exclusive rights are being sought herein for abstract ideas; they are not.

Rather, the present disclosure is focused on providing appropriately specific embodiments whose technical effects fully or partially solve particular technical problems, such as how to analyze mixed reality activity data to detect opportunities for real-world activity optimizations, how to improve the instructional content effectiveness of mixed reality data, and how to present to a user of an augmented reality device a result of comparing the user's actions with recommended actions. Other configured storage media, systems, and processes involving efficiency, reliability, user satisfaction, or waste are outside the present scope. Accordingly, vagueness, mere abstractness, lack of technical character, and accompanying proof problems are also avoided under a proper understanding of the present disclosure.

### Additional Combinations and Variations

Any of these combinations of software code, data structures, logic, components, communications, and/or their functional equivalents may also be combined with any of the systems and their variations described above. A process may include any steps described herein in any subset or combination or sequence which is operable. Each variant may occur alone, or in combination with any one or more of the other variants. Each variant may occur with any of the processes and each process may be combined with any one or more of the other processes. Each process or combination of processes, including variants, may be combined with any of the configured storage medium combinations and variants described above.

More generally, one of skill will recognize that not every part of this disclosure, or any particular details therein, are necessarily required to satisfy legal criteria such as enablement, written description, or best mode. Also, embodiments are not limited to the particular scenarios, motivating examples, operating environments, tools, peripherals, software process flows, identifiers, repositories, data structures, data selections, naming conventions, notations, control flows, or other implementation choices described herein. Any apparent conflict with any other patent disclosure, even from the owner of the present subject matter, has no role in interpreting the claims presented in this patent disclosure.

### Acronyms, Abbreviations, Names, and Symbols

Some acronyms, abbreviations, names, and symbols are defined below. Others are defined elsewhere herein, or do not require definition here in order to be understood by one of skill.
ALU: arithmetic and logic unit
API: application program interface
BIOS: basic input/output system
CD: compact disc
CPU: central processing unit
DVD: digital versatile disk or digital video disc
FPGA: field-programmable gate array
FPU: floating point processing unit
GDPR: General Data Protection Regulation
GPU: graphical processing unit
GUI: graphical user interface
HTTPS: hypertext transfer protocol, secure
IaaS or IAAS: infrastructure-as-a-service
LAN: local area network
OS: operating system
PaaS or PAAS: platform-as-a-service
RAM: random access memory
ROM: read only memory
TPU: tensor processing unit
UEFI: Unified Extensible Firmware Interface
UI: user interface
WAN: wide area network

### Some Additional Terminology

Reference is made herein to exemplary embodiments such as those illustrated in the drawings, and specific language is used herein to describe the same. But alterations and further modifications of the features illustrated herein, and additional technical applications of the abstract principles illustrated by particular embodiments herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage (particularly in non-technical usage), or in the usage of a particular industry, or in a particular dictionary or set of dictionaries. Reference numerals may be used with various phrasings, to help show the breadth of a term. Sharing a reference numeral does not mean necessarily sharing every aspect, feature, or limitation of every item referred to using the reference numeral. Omission of a reference numeral from a given piece of text does not necessarily mean that the content of a Figure is not being discussed by the text. The present disclosure asserts and exercises the right to specific and chosen lexicography. Quoted terms are being defined explicitly, but a term may also be defined implicitly without using quotation marks. Terms may be defined, either explicitly or implicitly, here in the Detailed Description and/or elsewhere in the application file.

A “computer system” (a.k.a. “computing system”) may include, for example, one or more servers, motherboards, processing nodes, laptops, tablets, personal computers (portable or not), personal digital assistants, smartphones, smartwatches, smart bands, cell or mobile phones, other mobile devices having at least a processor and a memory, video game systems, augmented reality systems, holographic projection systems, televisions, wearable computing systems, and/or other device(s) providing one or more processors controlled at least in part by instructions. The instructions may be in the form of firmware or other software in memory and/or specialized circuitry.

A “multithreaded” computer system is a computer system which supports multiple execution threads. The term “thread” should be understood to include code capable of or subject to scheduling, and possibly to synchronization. A thread may also be known outside this disclosure by another name, such as “task,” “process,” or “coroutine,” for example. However, a distinction is made herein between threads and processes, in that a thread defines an execution path inside a process. Also, threads of a process share a given address space, whereas different processes have different respective address spaces. The threads of a process may run in parallel, in sequence, or in a combination of parallel execution and sequential execution (e.g., time-sliced).

A “processor” is a thread-processing unit, such as a core in a simultaneous multithreading implementation. A processor includes hardware. A given chip may hold one or more processors. Processors may be general purpose, or they may be tailored for specific uses such as vector processing, graphics processing, signal processing, floating-point arithmetic processing, encryption, I/O processing, machine learning, and so on.

“Kernels” include operating systems, hypervisors, virtual machines, BIOS or UEFI code, and similar hardware interface software.

“Code” means processor instructions, data (which includes constants, variables, and data structures), or both instructions and data. “Code” and “software” are used interchangeably herein. Executable code, interpreted code, and firmware are some examples of code.

“Program” is used broadly herein, to include applications, kernels, drivers, interrupt handlers, firmware, state machines, libraries, and other code written by programmers (who are also referred to as developers) and/or automatically generated.

A “routine” is a callable piece of code which normally returns control to an instruction just after the point in a program execution at which the routine was called. Depending on the terminology used, a distinction is sometimes made elsewhere between a “function” and a “procedure”: a function normally returns a value, while a procedure does not. As used herein, “routine” includes both functions and procedures. A routine may have code that returns a value (e.g., sin (x)) or it may simply return without also providing a value (e.g., void functions).

“Service” means a consumable program offering, in a cloud computing environment or other network or computing system environment, which provides resources to multiple programs or provides resource access to multiple programs, or does both. A service implementation may itself include multiple applications or other programs.

“Cloud” means pooled resources for computing, storage, and networking which are elastically available for measured on-demand service. A cloud 136 may be private, public, community, or a hybrid, and cloud services may be offered in the form of infrastructure as a service (laaS), platform as a service (PaaS), software as a service (SaaS), or another service. Unless stated otherwise, any discussion of reading from a file or writing to a file includes reading/writing a local file or reading/writing over a network, which may be a cloud network or other network, or doing both (local and networked read/write). A cloud may also be referred to as a “cloud environment” or a “cloud computing environment”.

“Access” to a computational resource includes use of a permission or other capability to read, modify, write, execute, move, delete, create, or otherwise utilize the resource. Attempted access may be explicitly distinguished from actual access, but “access” without the “attempted” qualifier includes both attempted access and access actually performed or provided.

Herein, activity by a user refers to activity by a user device or activity by a user account, or by software on behalf of a user, or by hardware on behalf of a user. Activity is represented by digital data or machine operations or both in a computing system. Activity within the scope of any claim based on the present disclosure excludes human actions per se. Software or hardware activity “on behalf of a user” accordingly refers to software or hardware activity on behalf of a user device or on behalf of a user account or on behalf of another computational mechanism or computational artifact, and thus does not bring human behavior per se within the scope of any embodiment or any claim.

“Digital data” means data in a computing system, as opposed to data written on paper or thoughts in a person's mind, for example. Similarly, “digital memory” refers to a non-living device, e.g., computing storage hardware, not to human or other biological memory.

As used herein, “include” allows additional elements (i.e., includes means comprises) unless otherwise stated.

“Optimize” means to improve, not necessarily to perfect. For example, it may be possible to make further improvements in a program or an algorithm which has been optimized.

“Process” is sometimes used herein as a term of the computing science arts, and in that technical sense encompasses computational resource users, which may also include or be referred to as coroutines, threads, tasks, interrupt handlers, application processes, kernel processes, procedures, or object methods, for example. As a practical matter, a “process” is the computational entity identified by system utilities such as Windows® Task Manager, Linux® ps, or similar utilities in other operating system environments (marks of Microsoft Corporation, Linus Torvalds, respectively). “Process” may also be used as a patent law term of art, e.g., in describing a process claim as opposed to a system claim or an article of manufacture (configured storage medium) claim. Similarly, “method” is used herein primarily as a technical term in the computing science arts (a kind of “routine”) but it is also a patent law term of art (akin to a “process”). “Process” and “method” in the patent law sense are used interchangeably herein. Those of skill will understand which meaning is intended in a particular instance, and will also understand that a given claimed process or method (in the patent law sense) may sometimes be implemented using one or more processes or methods (in the computing science sense).

“Automatically” means by use of automation (e.g., general purpose computing hardware configured by software for specific operations and technical effects discussed herein), as opposed to without automation. In particular, steps performed “automatically” are not performed by hand on paper or in a person's mind, although they may be initiated by a human person or guided interactively by a human person. Automatic steps are performed with a machine in order to obtain one or more technical effects that would not be realized without the technical interactions thus provided. Steps performed automatically are presumed to include at least one operation performed proactively.

A result is computationally “based on” an input when computation of the result includes the value of the input in a meaningful way. In other words, when there is at least one input value change which will cause a corresponding value change in the result.

One of skill understands that technical effects are the presumptive purpose of a technical embodiment. The mere fact that calculation is involved in an embodiment, for example, and that some calculations can also be performed without technical components (e.g., by paper and pencil, or even as mental steps) does not remove the presence of the technical effects or alter the concrete and technical nature of the embodiment, particularly in real-world embodiment implementations. Mixed reality data stream analysis operations such as getting 802 a candidate stream into a computing system, obtaining 804 in a computing system a guide stream, detecting 806 deviations between data streams without necessarily first or simultaneously displaying the data streams, actuating 810 hardware, and many other operations discussed herein (whether recited in the Figures or not), are understood to be inherently digital. A human mind cannot interface directly with a CPU or other processor, or with RAM or other digital storage, to read and write the necessary data to perform the mixed reality data stream analysis and device control facilitation steps 900 taught herein even in a hypothetical or actual prototype situation, much less in an embodiment's real world large computing environment. This would all be well understood by persons of skill in the art in view of the present disclosure.

“Computationally” likewise means a computing device (processor plus memory, at least) is being used, and excludes obtaining a result by mere human thought or mere human action alone. For example, doing arithmetic with a paper and pencil is not doing arithmetic computationally as understood herein. Computational results are faster, broader, deeper, more accurate, more consistent, more comprehensive, and/or otherwise provide technical effects that are beyond the scope of human performance alone. “Computational steps” are steps performed computationally. Neither “automatically” nor “computationally” necessarily means “immediately”. “Computationally” and “automatically” are used interchangeably herein.

“Proactively” means without a direct request from a user, and indicates machine activity rather than human activity. Indeed, a user may not even realize that a proactive step by an embodiment was possible until a result of the step has been presented to the user. Except as otherwise stated, any computational and/or automatic step described herein may also be done proactively.

“Based on” means based on at least, not based exclusively on. Thus, a calculation based on X depends on at least X, and may also depend on Y.

Throughout this document, use of the optional plural “(s)”, “(es)”, or “(ies)” means that one or more of the indicated features is present. For example, “processor(s)” means “one or more processors” or equivalently “at least one processor”.

“At least one” of a list of items means one of the items, or two of the items, or three of the items, and so on up to and including all N of the items, where the list is a list of N items. The presence of an item in the list does not require the presence of the item (or a check for the item) in an embodiment. For instance, if an embodiment of a system is described herein as including at least one of A, B, C, or D, then a system that includes A but does not check for B or C or D is an embodiment, and so is a system that includes A and also includes B but does not include or check for C or D. Similar understandings pertain to items which are steps or step portions or options in a method embodiment. This is not a complete list of all possibilities; it is provided merely to aid understanding of the scope of “at least one” that is intended herein.

For the purposes of United States law and practice, use of the word “step” herein, in the claims or elsewhere, is not intended to invoke means-plus-function, step-plus-function, or 35 United State Code Section 112 Sixth Paragraph/Section 112(f) claim interpretation. Any presumption to that effect is hereby explicitly rebutted.

For the purposes of United States law and practice, the claims are not intended to invoke means-plus-function interpretation unless they use the phrase “means for”. Claim language intended to be interpreted as means-plus-function language, if any, will expressly recite that intention by using the phrase “means for”. When means-plus-function interpretation applies, whether by use of “means for” and/or by a court's legal construction of claim language, the means recited in the specification for a given noun or a given verb should be understood to be linked to the claim language and linked together herein by virtue of any of the following: appearance within the same block in a block diagram of the figures, denotation by the same or a similar name, denotation by the same reference numeral, a functional relationship depicted in any of the figures, a functional relationship noted in the present disclosure's text. For example, if a claim limitation recited a “zac widget” and that claim limitation became subject to means-plus-function interpretation, then at a minimum all structures identified anywhere in the specification in any figure block, paragraph, or example mentioning “zac widget”, or tied together by any reference numeral assigned to a zac widget, or disclosed as having a functional relationship with the structure or operation of a zac widget, would be deemed part of the structures identified in the application for zac widgets and would help define the set of equivalents for zac widget structures.

One of skill will recognize that this disclosure discusses various data values and data structures, and recognize that such items reside in a memory (RAM, disk, etc.), thereby configuring the memory. One of skill will also recognize that this disclosure discusses various algorithmic steps which are to be embodied in executable code in a given implementation, and that such code also resides in memory, and that it effectively configures any general-purpose processor which executes it, thereby transforming it from a general-purpose processor to a special-purpose processor which is functionally special-purpose hardware.

Accordingly, one of skill would not make the mistake of treating as non-overlapping items (a) a memory recited in a claim, and (b) a data structure or data value or code recited in the claim. Data structures and data values and code are understood to reside in memory, even when a claim does not explicitly recite that residency for each and every data structure or data value or piece of code mentioned. Accordingly, explicit recitals of such residency are not required. However, they are also not prohibited, and one or two select recitals may be present for emphasis, without thereby excluding all the other data values and data structures and code from residency. Likewise, code functionality recited in a claim is understood to configure a processor, regardless of whether that configuring quality is explicitly recited in the claim.

Throughout this document, unless expressly stated otherwise any reference to a step in a process presumes that the step may be performed directly by a party of interest and/or performed indirectly by the party through intervening mechanisms and/or intervening entities, and still lie within the scope of the step. That is, direct performance of the step by the party of interest is not required unless direct performance is an expressly stated requirement. For example, a computational step on behalf of a party of interest, such as actuating, compositing, configuring, creating, deriving, detecting, directing, emitting, emphasizing, gathering, getting, identifying, measuring, monitoring, obtaining, optimizing, playing back, producing, receiving, recording, rendering, representing, searching, submitting, summarizing, synchronizing, tracking (and actuates, actuated, composites, composited, etc.) with regard to a destination or other subject may involve intervening action, such as the foregoing or such as forwarding, copying, uploading, downloading, encoding, decoding, compressing, decompressing, encrypting, decrypting, authenticating, invoking, and so on by some other party or mechanism, including any action recited in this document, yet still be understood as being performed directly by or on behalf of the party of interest. Example verbs listed here may overlap in meaning or even be synonyms; separate verb names do not dictate separate functionality in every case.

Whenever reference is made to data or instructions, it is understood that these items configure a computer-readable memory and/or computer-readable storage medium, thereby transforming it to a particular article, as opposed to simply existing on paper, in a person's mind, or as a mere signal being propagated on a wire, for example. For the purposes of patent protection in the United States, a memory or other storage device or other computer-readable storage medium is not a propagating signal or a carrier wave or mere energy outside the scope of patentable subject matter under United States Patent and Trademark Office (USPTO) interpretation of the In re Nuijten case. No claim covers a signal per se or mere energy in the United States, and any claim interpretation that asserts otherwise in view of the present disclosure is unreasonable on its face. Unless expressly stated otherwise in a claim granted outside the United States, a claim does not cover a signal per se or mere energy.

Moreover, notwithstanding anything apparently to the contrary elsewhere herein, a clear distinction is to be understood between (a) computer readable storage media and computer readable memory, on the one hand, and (b) transmission media, also referred to as signal media, on the other hand. A transmission medium is a propagating signal or a carrier wave computer readable medium. By contrast, computer readable storage media and computer readable memory and computer readable storage devices are not propagating signal or carrier wave computer readable media. Unless expressly stated otherwise in the claim, “computer readable medium” means a computer readable storage medium, not a propagating signal per se and not mere energy.

An “embodiment” herein is an example. The term “embodiment” is not interchangeable with “the invention”. Embodiments may freely share or borrow aspects to create other embodiments (provided the result is operable), even if a resulting combination of aspects is not explicitly described per se herein. Requiring each and every permitted combination to be explicitly and individually described is unnecessary for one of skill in the art, and would be contrary to policies which recognize that patent specifications are written for readers who are skilled in the art. Formal combinatorial calculations and informal common intuition regarding the number of possible combinations arising from even a small number of combinable features will also indicate that a large number of aspect combinations exist for the aspects described herein. Accordingly, requiring an explicit recitation of each and every combination would be contrary to policies calling for patent specifications to be concise and for readers to be knowledgeable in the technical fields concerned.

### LIST OF REFERENCE NUMERALS

The following list is provided for convenience and in support of the drawing figures and as part of the text of the specification, which describe aspects of embodiments by reference to multiple items. Items not listed here may nonetheless be part of a given embodiment. For better legibility of the text, a given reference number is recited near some, but not all, recitations of the referenced item in the text. The same reference number may be used with reference to different examples or different instances of a given item. The list of reference numerals is:
100 operating environment, also referred to as computing environment; includes one or more systems 102
101 machine in a system 102, e.g., any device having at least a processor 110 and a memory 112 and also having a distinct identifier such as an IP address or a MAC (media access control) address; may be a physical machine or be a virtual machine implemented on physical hardware
102 computer system, also referred to as a “computational system” or “computing system”, and when in a network may be referred to as a “node”
104 users, e.g., user of an enhanced system 202
106 peripheral device
108 network generally, including, e.g., LANs, WANs, software-defined networks, clouds, and other wired or wireless networks
110 processor or set of processors; includes hardware
112 computer-readable storage medium, e.g., RAM, hard disks
114 removable configured computer-readable storage medium
116 instructions executable with processor; may be on removable storage media or in other memory (volatile or nonvolatile or both)
118 digital data in a system 102; data structures, values, source code, and other examples are discussed herein
120 kernel(s), e.g., operating system(s), BIOS, UEFI, device drivers; also refers to an execution engine such as a language runtime
122 software tools, software applications, security controls; computational
124 user interface in a computing system
126 display screens, also referred to as “displays”
128 computing hardware not otherwise associated with a reference number 106, 108, 110, 112, 114
130 hardware input device in a computing system; for input to system
132 hardware output device in a computing system; for output from system
134 data stream, as represented in a computing system; does not necessarily contain mixed reality data
136 cloud, also referred to as cloud environment or cloud computing environment
202 enhanced computing system, i.e., system 102 enhanced with functionality 204 as taught herein
204 mixed reality data stream analysis and device control facilitation functionality, a.k.a. “functionality 204” (also referred to in relevant part as “mixed reality data stream analysis functionality” or as “device control facilitation functionality 204”), e.g., software or specialized hardware which performs or is configured to perform steps 806 and 808, or steps 806 and 810, or steps 808, 812, and 816, or steps 910 and 808, or steps 910 and 810, or steps 806 and 920, or steps 910 and 920, or any software or hardware which performs or is configured to perform a novel method 900 or a computational mixed reality data stream analysis functionality activity first disclosed herein or a computational device control facilitation functionality activity first disclosed herein
206 computationally analyze one or more mixed reality data streams, e.g., by computationally performing one or more of: deviation detection 806, summarization 426, optimization 418, amortization 448, search for outlier 444, search for extreme run 450, or derivation 424 to create an articulated body representation 436 or create a feedback stream 308
208 mixed reality, as represented in a computing system, e.g., augmented reality data, or any data which includes both a sensor-based representation of the real-world (e.g., still photographic images or video of real-world people or objects or environment, visual recording, audio recording, or sensor telemetry) and computer-generated data (e.g., ink strokes, text overlay, animation, or ghost mode output)
210 data stream 134 which includes mixed reality data 208
212 work object, as represented in a computing system; may be a real-world object or a virtual object which does not necessarily have any current real-world counterpart or existence
214 real-world object, as represented in a computing system; has (or at its time of creation as a digital artifact had) a real-world counterpart
216 real-world environment, e.g., work area, lab, factory, etc., as represented in a computing system; has (or at its time of creation as a digital artifact had) a real-world counterpart
300 example mixed reality analysis architecture; 300 also refers to the data flow diagram in FIG. 3; 300 also refers to mixed reality analysis methods and other methods that are illustrated by or consistent with the FIG. 3 data flow diagram or any variation of the FIG. 3 data flow diagram described herein
302 video, as represented in a computing system
304 data from a sensor 310, as represented in a computing system; also referred to as telemetry
306 guidance forge: software, or software hardware combination, which implements a functionality 204 in a computing system; a guidance forge computationally creates and outputs a feedback stream from two or more input streams 134 which collectively or individually include mixed reality data
308 feedback stream, a stream 134 based on at least a deviation 406 between at least two streams 134 which include at least one mixed reality stream 210
310 sensor; a mechanism or other device which includes hardware and which detects or measures a physical property, and which and records, indicates, or otherwise responds to the detected or measured physical property by emitting an electronic signal
314 operation, task, job, or other defined activity to be performed 402 representation of a device or an object in a computing system
404 deviation size, as represented in a computing system
406 deviation between two or more streams 134, as represented in a computing system
408 portion of a stream 134, as represented in a computing system
410 command, movement, or other action to control a device or object, as represented in a computing system; configuring, constructing, disassembling, emptying, filling, inspecting, monitoring, operating, positioning, repairing, testing, and upgrading are examples of controlling 410
412 response to a control action, as represented in a computing system
414 computational activity of compositing two or more streams 134 or portions thereof, in a computer graphics sense; visually overlaying one stream on another stream is an example of compositing
416 result in a computing system of compositing two or more streams or portions thereof, in a computer graphics sense, also referred to as a composition
418 computational activity of optimizing one or more streams 134 or portions thereof
420 optimization metric, e.g., measurement of time, deviation size or other property, user satisfaction per survey results, or other measurable characteristic of a stream 134 which is associated with an optimization 418 effort
422 stream or other result in a computing system of optimization activity 418
424 derivation of a stream 134, e.g., another data stream based at least in part on condensing, extracting a skeleton 436, filtering, interpolating, optimizing, sampling, summarizing, or otherwise transforming the stream in a computing system; 424 also refers to the computational activity of generating a derivation
426 computational activity of summarizing a stream 134 or portion thereof, e.g., as performed by a machine learning model or a keyframe identification algorithm
428 summarization algorithm, e.g., keyframe identification, neural net algorithm
430 stream or other result in a computing system of summarization activity 426
432 computational activity of synchronizing two or more streams 134 or portions thereof, e.g., by mapping keyframes or milestones in a guide stream to frames or events in a candidate stream, with associated compression or elongation or pausing or skipping in either or both streams in between the mapped stream playback or other occurrence positions; 432 also refers to a stream resulting from such computational activity
434 articulated body, i.e., a body or body portion having inflexible or low flexibility segments connected at one or more joints; e.g., hand, arm, leg, tentacle (represented as multiple connected segments), skeleton
436 representation in a computing system of an articulated body
438 live video, e.g., video 592 displayed at location Y showing an item at location X, in which the delay between capturing a video frame at x and displaying the video frame at Y is within one second of the transit time of the video frame from X to Y
440 live-with-delay video, e.g., video 592 displayed at location Y showing an item at location X, in which the delay between capturing a video frame at x and displaying the video frame at Y is within thirty-one seconds of the transit time of the video frame from X to Y
442 anchor in a mixed reality data stream, e.g., spatial point of reference
444 statistical outlier
446 run of a data stream, e.g., presentation or playback or recording of the data stream in a computing system
448 amortization of a data stream
450 extreme run 446, e.g., fastest run, slowest run
452 physical real-world location
454 search constraint, as represented in a computing system
456 deviation property, e.g., size, frequency, recency, pattern, as represented in a computing system
458 stream identifier, as represented in a computing system
460 search result, as represented in a computing system
502 depth map, as represented in a computing system
504 spatial map, as represented in a computing system
506 spatiotemporal data, as represented in a computing system; e.g., spatial data with a timestamp, heat map data with a timestamp, distribution map data with a timestamp, frequency map data with a time stamp, other temporal data which overlays spatial data
508 torque, as represented in a computing system
510 holographic data, as represented in a computing system
512 physical tool, as represented in a computing system or in real-world per discussion's context (presume digital representation)
514 humidity, as represented in a computing system
516 human hand, as represented in a computing system or in real-world per discussion's context (presume digital representation)
518 human limb, as represented in a computing system or in real-world per discussion's context (presume digital representation)
520 human body portion, as represented in a computing system or in real-world per discussion's context (presume digital representation)
522 robot hand, as represented in a computing system or in real-world per discussion's context (presume digital representation)
524 robot limb, as represented in a computing system or in real-world per discussion's context (presume digital representation)
526 robot portion, as represented in a computing system or in real-world per discussion's context (presume digital representation)
528 head pose, as represented in a computing system; also referred to as head tracking
530 respiration rate or volume, as represented in a computing system
532 eye tracking, as represented in a computing system
534 temperature, as represented in a computing system
536 position of an articulated body or portion thereof, as represented in a computing system
538 speed of an articulated body or portion thereof, as represented in a computing system
540 acceleration of an articulated body or portion thereof, as represented in a computing system
542 position of an item or portion thereof, as represented in a computing system
544 speed of an item or portion thereof, as represented in a computing system
546 acceleration of an item or portion thereof, as represented in a computing system
548 blood pressure, as represented in a computing system
550 pressure, as represented in a computing system
552 sensor 310 designed for placement on skin
554 sensor 310 designed for placement within a living body
556 gyroscopic data in a computing system
558 electromagnetic data in a computing system
560 electric power data in a computing system
562 electromagnetic field data in a computing system
564 chemical, pharmaceutical, or biological data in a computing system
566 chemical, pharmaceutical, or biological composition data in a computing system
568 relative concentration data in a computing system, e.g., parts per million, moles, percentage
570 physical condition sensed (detected or measured) by a sensor 310
572 computational activity of motion capture; 572 also refers to data resulting from such computational activity
574 computational activity of movement extraction
576 movement, as represented in a computing system; 572 also refers to data resulting from computational activity which extracts or otherwise detects or measures movement
578 search tool; also refers to computational activity of searching based on at least one constraint 454
580 visual data in a computing system
582 text data in a computing system
584 sound (a.k.a. audio) data in a computing system
586 color data in a computing system
588 haptic data in a computing system
590 data in a computing system which is not visual data per se, e.g., any of these data: torque, humidity, respiration, temperature, pressure, position, speed, acceleration, chemical composition, relative concentration, haptic, power
592 video (visual over time, often with audio) data in a computing system
594 camera, as represented in a computing system; an example of a sensor 310
596 mark in a data stream 134; digital
602 headset device, also referred to as head-mounted device; includes hardware; as defined herein, in some embodiments a “headset” includes a physical device suitable to be worn on a human user's head, but in some embodiments the “headset” is virtual in the sense that the physical device portion of the “headset” is a remotely controlled robot or a remotely controlled drone which is not suitable to be worn on a human user's head
604 flat screen display device; includes hardware
606 mobile device, e.g., smart phone or wearable computing device; includes hardware
608 projection device; includes hardware
610 workstation; an example of a computing device 101
612 tablet; an example of a computing device 101
614 laptop; an example of a computing device 101
616 display output mode
618 software or device which renders an image; 618 also refers to the computational activity of rendering an image (a video includes a sequence of images and thus video can be rendered)
800 flowchart; 800 also refers to mixed reality data stream analysis methods and device control facilitation methods that are illustrated by or consistent with the FIG. 8 flowchart or any variation of the FIG. 8 flowchart described herein
802 computationally get a candidate stream 210, e.g., via an API
804 computationally obtain a guide stream 210, e.g., via an API
806 computationally detect a deviation between at least two streams;
806 also refers to software which performs this activity
808 computationally create a feedback stream based on at least a detected 806 deviation; also referred to as updating the feedback stream
810 computationally or otherwise electronically actuate a hardware output device based on at least a detected 806 deviation
812 computationally identify a control action, e.g., identify an attempt to control a device
814 direct a control action at a work object
816 computationally monitor an item or an environment or both for a response to a control attempt
900 flowchart; 900 also refers to mixed reality data stream analysis methods and device control facilitation methods that are illustrated by or consistent with the FIG. 9 flowchart, which incorporates the FIG. 3 data flow diagram, the actions listed in FIG. 7, the FIG. 8 flowchart, and other steps taught herein, or methods that are illustrated by or consistent with any variation of the FIG. 9 flowchart described herein
902 computationally submit data to a search mechanism, e.g., via an API
904 computationally receive data from a search mechanism, e.g., via an API; 902 and 904 are also referred to collectively as “searching”
906 computationally configure a user interface, e.g., by emitting sound or displaying images; also referred to as presenting data or providing data via the user interface, e.g., playing video data via the user interface
908 computationally produce a data stream 210; also referred to a generating the data stream
910 computationally measure a property (e.g., size) of a deviation 406
912 computationally emit an output, e.g., sound, haptic vibration, image
914 output emitted from a device 132
916 computationally gather sensor telemetry, e.g., via an API
918 computationally record visual, sound, telemetry, or other data
920 computationally emphasize a deviation in output 914, e.g., by visual or audible or tactile emphasis in a user interface
922 any step or item discussed in the present disclosure that has not been assigned some other reference numeral; 922 may thus be shown expressly as a reference numeral for various steps or items or both, and may be added as a reference numeral (in the current disclosure or any subsequent patent application which claims priority to the current disclosure) for various steps or items or both without thereby adding new matter

### CONCLUSION

In some embodiments, mixed reality instructional technology is enhanced with mixed reality data stream analysis and device control facilitation functionality 204. Comparison of a guide mixed reality data stream 210 to a candidate mixed reality data stream 210 detects 806 a deviation 406, e.g., different hand movement 576, different tool placement relative to a work object 212, or different sensor telemetry 304. Experiencing a feedback stream 308 of output 914 that is based on the deviation facilitates device 212 control and helps candidates improve their skills. Some feedback output emphasizes 920 deviation size 404, e.g., by varying colors, sounds, or haptic output proportionally to the deviation size. Some feedback output renders 618 a translucent or skeletal guide overlaid 414 on a live 438 video 592 of current candidate activity. Some embodiments support searches 902, 904 whose results 460 show, e.g., how a certain expert performed a task 314 differently than the candidate, or examples of a certain task 314 such as widget replacement in the field. Stream optimization 418, summarization 426, synchronization 432, and other stream derivation 424 functionality is provided.

Embodiments are understood to also themselves include or benefit from tested and appropriate security controls and privacy controls such as the General Data Protection Regulation (GDPR). Use of the tools and techniques taught herein is compatible with use of such controls.

Although Microsoft technology is used in some motivating examples, the teachings herein are not limited to use in technology supplied or administered by Microsoft. Under a suitable license, for example, the present teachings could be embodied in software or services provided by other cloud service providers.

Although particular embodiments are expressly illustrated and described herein as processes, as configured storage media, or as systems, it will be appreciated that discussion of one type of embodiment also generally extends to other embodiment types. For instance, the descriptions of processes in connection with the Figures also help describe configured storage media, and help describe the technical effects and operation of systems and manufactures like those discussed in connection with other Figures. It does not follow that any limitations from one embodiment are necessarily read into another. In particular, processes are not necessarily limited to the data structures and arrangements presented while discussing systems or manufactures such as configured memories.

Those of skill will understand that implementation details may pertain to specific code, such as specific thresholds, comparisons, specific kinds of platforms or programming languages or architectures, specific scripts or other command lists, and specific computing environments, and thus need not appear in every embodiment. Those of skill will also understand that program identifiers and some other terminology used in discussing details are implementation-specific and thus need not pertain to every embodiment. Nonetheless, although they are not necessarily required to be present here, such details may help some readers by providing context and/or may illustrate a few of the many possible implementations of the technology discussed herein.

With due attention to the items provided herein, including technical processes, technical effects, technical mechanisms, and technical details which are illustrative but not comprehensive of all claimed or claimable embodiments, one of skill will understand that the present disclosure and the embodiments described herein are not directed to subject matter outside the technical arts, or to any idea of itself such as a principal or original cause or motive, or to a mere result per se, or to a mental process or mental steps, or to a business method or prevalent economic practice, or to a mere method of organizing human activities, or to a law of nature per se, or to a naturally occurring thing or process, or to a living thing or part of a living thing, or to a mathematical formula per se, or to isolated software per se, or to a merely conventional computer, or to anything wholly imperceptible or any abstract idea per se, or to insignificant post-solution activities, or to any method implemented entirely on an unspecified apparatus, or to any method that fails to produce results that are useful and concrete, or to any preemption of all fields of usage, or to any other subject matter which is ineligible for patent protection under the laws of the jurisdiction in which such protection is sought or is being licensed or enforced.

Reference herein to an embodiment having some feature X and reference elsewhere herein to an embodiment having some feature Y does not exclude from this disclosure embodiments which have both feature X and feature Y, unless such exclusion is expressly stated herein. All possible negative claim limitations are within the scope of this disclosure, in the sense that any feature which is stated to be part of an embodiment may also be expressly removed from inclusion in another embodiment, even if that specific exclusion is not given in any example herein. The term “embodiment” is merely used herein as a more convenient form of “process, system, article of manufacture, configured computer readable storage medium, and/or other example of the teachings herein as applied in a manner consistent with applicable law.” Accordingly, a given “embodiment” may include any combination of features disclosed herein, provided the embodiment is consistent with at least one claim.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific technical effects or technical features of an example may be omitted, renamed, grouped differently, repeated, instantiated in hardware and/or software differently, or be a mix of effects or features appearing in two or more of the examples. Functionality shown at one location may also be provided at a different location in some embodiments; one of skill recognizes that functionality modules can be defined in various ways in a given implementation without necessarily omitting desired technical effects from the collection of interacting modules viewed as a whole. Distinct steps may be shown together in a single box in the Figures, due to space limitations or for convenience, but nonetheless be separately performable, e.g., one may be performed without the other in a given performance of a method.

Reference has been made to the figures throughout by reference numerals. Any apparent inconsistencies in the phrasing associated with a given reference numeral, in the figures or in the text, should be understood as simply broadening the scope of what is referenced by that numeral. Different instances of a given reference numeral may refer to different embodiments, even though the same reference numeral is used. Similarly, a given reference numeral may be used to refer to a verb, a noun, and/or to corresponding instances of each, e.g., a processor 110 may process 110 instructions by executing them.

As used herein, terms such as “a”, “an”, and “the” are inclusive of one or more of the indicated item or step. In particular, in the claims a reference to an item generally means at least one such item is present and a reference to a step means at least one instance of the step is performed. Similarly, “is” and other singular verb forms should be understood to encompass the possibility of “are” and other plural forms, when context permits, to avoid grammatical errors or misunderstandings.

Headings are for convenience only; information on a given topic may be found outside the section whose heading indicates that topic.

All claims and the abstract, as filed, are part of the specification. The abstract is provided for convenience and for compliance with patent office requirements; it is not a substitute for the claims and does not govern claim interpretation in the event of any apparent conflict with other parts of the specification. Similarly, the summary is provided for convenience and does not govern in the event of any conflict with the claims or with other parts of the specification. Claim interpretation shall be made in view of the specification as understood by one of skill in the art; it is not required to recite every nuance within the claims themselves as though no other disclosure was provided herein.

To the extent any term used herein implicates or otherwise refers to an industry standard, and to the extent that applicable law requires identification of a particular version of such as standard, this disclosure shall be understood to refer to the most recent version of that standard which has been published in at least draft form (final form takes precedence if more recent) as of the earliest priority date of the present disclosure under applicable patent law.

While exemplary embodiments have been shown in the drawings and described above, it will be apparent to those of ordinary skill in the art that numerous modifications can be made without departing from the principles and concepts set forth in the claims, and that such modifications need not encompass an entire abstract concept. Although the subject matter is described in language specific to structural features and/or procedural acts, it is to be understood that the subject matter defined in the appended claims is not necessarily limited to the specific technical features or acts described above the claims. It is not necessary for every means or aspect or technical effect identified in a given definition or example to be present or to be utilized in every embodiment. Rather, the specific features and acts and effects described are disclosed as examples for consideration when implementing the claims.

All changes which fall short of enveloping an entire abstract idea but come within the meaning and range of equivalency of the claims are to be embraced within their scope to the full extent permitted by law.

What is claimed is:

1. A method of analyzing mixed reality data streams based on controlling a real-world device, the method comprising automatically:
getting a candidate mixed reality data stream;
obtaining a guide mixed reality data stream, at least one of the mixed reality data streams including a digital representation of the real-world device;
computationally detecting a deviation between the candidate mixed reality data stream and the guide mixed reality data stream;
computationally creating a feedback stream based at least in part on the deviation;
actuating a user interface hardware output device according to at least a portion of the feedback stream; and
at least one of: computationally generating an optimization stream based on at least an optimization metric and at least a portion of each of the mixed reality data streams, wherein the optimization stream includes an optimization of at least one of: a measurement of time, a user satisfaction per survey results, a lowest number of deviations, a smallest cumulative size of deviations, or a measurable characteristic of a data stream other than a deviation size per se, or computationally making a summarization stream based on at least a summarization algorithm and at least a portion of each of the mixed reality data streams.

2. The method of claim 1, further comprising:
identifying in at least one of the mixed reality data streams a digital representation of a control action which is directed at the real-world device; and
monitoring the real-world device for a response to the control action.

3. The method of claim 1, further comprising:
submitting, to a search mechanism, a search constraint and an identifier of at least one of the mixed reality data streams to be searched based on at least the search constraint;
receiving a search result from the search mechanism; and
configuring a user interface according to at least a portion of the search result.

4. The method of claim 1, wherein at least one of the mixed reality data streams includes at least one of:
head pose data;
eye tracking data;
articulated body speed data; or
articulated body acceleration data.

5. The method of claim 1, further comprising computationally synchronizing respective portions of at least two of the mixed reality data streams for presentation in the user interface.

6. The method of claim 1, further comprising computationally forming a composition stream by compositing at least a portion of each of the mixed reality data streams.

7. A computing system which is configured to provide user guidance about controlling a real-world device, the user guidance based on an analysis of digital mixed reality data streams, the computing system comprising:
a digital memory;
a user interface comprising at least one hardware output device, the user interface configured to emit an output based on at least one of: visual data, textual data, sound data, color data, haptic data;
a processor set comprising at least one processor, the processor set in operable communication with the digital memory and the user interface;
a guidance formulation subsystem which is configured to, upon execution by the processor set, detect a deviation between a candidate mixed reality data stream and a guide mixed reality data stream, at least one of the mixed reality data streams including a digital representation of the real-world device, create a feedback stream based at least in part on the deviation, and actuate the user interface hardware output device according to at least a portion of the feedback stream; and
wherein the guidance formulation subsystem is configured to, upon execution by the processor set, create the feedback stream at least in part by computationally compositing a guide derivation of the guide mixed reality data stream over a candidate derivation of the candidate mixed reality data stream, wherein at least a portion of the guide derivation is at least one of: translucent, displayed as a skeleton, or visually blocking less than one third of the candidate derivation.

8. The computing system of claim 7, wherein the guidance formulation subsystem is configured to, upon execution by the processor set, measure a size of the deviation, create the feedback stream based at least in part on the size of the deviation, and actuate the user interface hardware output device according to at least the size of the deviation.

9. The computing system of claim 7, wherein at least a portion of the guide derivation is displayed as an outline.

10. The computing system of claim 7, wherein at least one of the mixed reality data streams includes an anchor data structure, wherein the anchor data structure operates as a shared reference point or an origin in a shared coordinate system, and wherein the anchor data structure corresponds to at least one of:
a work object which is a real-world object or a virtual object, not the anchor data structure; or
a physical real-world location.

11. The computing system of claim 7, wherein at least one of the mixed reality data streams includes at least one of:
depth map data;
spatial map data;
spatiotemporal data; or
holographic data.

12. The computing system of claim 7, wherein at least one of the mixed reality data streams includes a digital articulated body representation which digitally represents at least one of:
a human hand;
a human limb;
at least a portion of a human body;
a robotic hand;
a robotic limb;
at least a portion of a robotic mechanism;
a manually operable non-powered physical tool other than a software tool; or
a powered physical tool other than a software tool.

13. The computing system of claim 7, wherein at least one of the mixed reality data streams includes at least one of:
articulated body position data;
articulated body speed data;
articulated body acceleration data;
respiration data;
blood pressure data;
living body temperature data;
skin sensor data; or
ingested sensor data.

14. The computing system of claim 7, wherein at least one of the mixed reality data streams includes at least one of:
spatiotemporal data;
speed data other than articulated body speed data;
acceleration data other than articulated body acceleration data;
gyroscopic data;
pressure data other than blood pressure data;
torque data;
temperature data other than living body temperature data;
humidity data;
electromagnetic power data;
electromagnetic field data;
chemical composition data;
relative concentration data;
sensor data representing a real-world non-human object physical condition; or
sensor data representing a real-world environment physical condition.

15. The computing system of claim 7, wherein the hardware output device includes or resides within at least one of:
a head-mounted device;
a mobile device;
a flat screen display device;
a projection device;
a laptop;
a tablet; or
a workstation.

16. A computer-readable storage device configured with data and instructions which upon execution by a processor cause a computing system to perform a method of providing user guidance about controlling a real-world device, the user guidance based on an analysis of digital mixed reality data streams, the method comprising:
detecting a deviation between a candidate mixed reality data stream and a guide mixed reality data stream, at least one of the mixed reality data streams including a digital representation of the real-world device;
creating a feedback stream based at least in part on the deviation;
actuating a user interface hardware output device according to at least a portion of the feedback stream; and
searching at least one of the data streams for at least one of: a lowest deviation run, a greatest deviation run, or an amortized analysis result, wherein “run” means a video sequence including multiple frames.

17. The computer-readable storage device of claim 16, wherein the candidate mixed reality data stream includes a live video stream or a live-with-delay video stream.

18. The computer-readable storage device of claim 16, wherein creating the feedback stream comprises compositing multiple data streams.

19. The computer-readable storage device of claim 16, wherein the method further comprises searching at least one of the data streams.

20. The computer-readable storage device of claim 16, wherein the method further comprises producing at least one of the mixed reality data streams, and the producing comprises at least one of: capturing motion data, extracting movement data from a video, or gathering sensor telemetry data.
